(19) United States
(12) Patent Application Publication
(10) Pub. No.: US 2018/0018602 A1
(43) Pub. Date: Jan. 18, 2018

(54) DETERMINING RISK LEVEL AND MATURITY OF COMPLIANCE ACTIVITIES

(71) Applicant: MCS2, LLC, Dublin, OH (US)

(72) Inventors: John P. DiMaggio, Powell, OH (US); Edward N. Stone, Dublin, OH (US)

(21) Appl. No.: 15/715,588

(22) Filed: Sep. 26, 2017

Related U.S. Application Data
(63) Continuation-in-part of application No. 15/330,967, filed on Feb. 25, 2016.
Application No. 15/330,967 is a continuation-in-part of application No. 15/207,469, filed on Jul. 11, 2016.

(51) Int. Cl. G06Q 10/06; G06N 99/00; G06F 17/30

(52) U.S. Cl. CPC G06Q 10/0635; G06Q 10/0637; G06F 17/30994; G06N 99/005

(57) ABSTRACT

The subject disclosure relates to determining maturity levels and risk scores associated with compliance activities and remediation activities of covered entities. In an example, a method comprises determining, by a system operatively coupled to a processor, a maturity level representing a state of compliance based in part on a comparison of a set of compliance program data or a set of remediation data to a set of requirement data. Furthermore, in an aspect, the method comprises generating, by the system, a risk score representing an estimated impact of threat data, vulnerability data, or non-compliance data on a set of protected information data based on a comparison of a first value corresponding to a maturity level to one or more values corresponding to a threshold maturity level, wherein threshold maturity level is based at least in part on a set of risk criteria.

### PRIORITY

This application claims priority to U.S. Provisional Patent Application No. 62/120,972 filed on Feb. 26, 2015 and entitled “METHOD AND SYSTEM FOR MANAGING COMPLIANCE PLANS”, U.S. Non-Provisional patent application Ser. No. 15/330,967 filed on Feb. 25, 2016 and entitled “METHODS AND SYSTEMS FOR MANAGING COMPLIANCE PLANS”, and U.S. Non-Provisional patent application Ser. No. 15/207,469 filed on Jul. 11, 2016 and entitled “METHODS AND SYSTEMS FOR STORING AND VISUALIZING MANAGED COMPLIANCE PLANS”. The entirety of the aforementioned applications are incorporated by reference herein.

### BACKGROUND

Managing compliance with recent healthcare laws and regulations has become an issue for those in the healthcare industry. The Health Insurance Portability and Accountability Act (HIPAA) law was enacted in 1996 and mandates the security and confidentiality of medical patient information and data. The Health Information Technology for Economic and Clinical Health (HITECH) Act was enacted in 2009 and set meaningful use of interoperable Electronic Health Record (EHR) adoption in the health care system as a critical national goal and incentivized EHR adoption.

These laws, and associated regulations promulgated therefrom, are administered by the Office for Civil Rights (OCR) and the Department of Health and Human Services, and apply to all entities covered by the HIPAA and HITECH regulations (Covered Entities) and their Business Associates who have access to protected health information of the Covered Entity. These organizations can include: hospitals, physician provider practices, pharmacies, long term care organizations, homecare, hospice, labs, diagnostic companies, collection agencies, contractors, cloud-based software providers, and other such organizations. Entities subject to these laws and regulations are morally and legally obligated to comply with hundreds of complex regulations as well as embrace a continual stream of newly emerging or amended regulations. An entity's failure to comply with applicable laws and regulations can result in sanctions, fines, imprisonment and less of governmental funding for certain organizations participating in the Meaningful Use Incentive Programs.

Federal-funding requirements, and the steep financial penalties affiliated with non-compliance have made the need for comprehensive, recurring and remediated assessments even more critical. Since 2009, breach reporting requirements tied to Meaningful Use incentives have revealed more than 900 incidents compromising the personal information of about 30 million affected individuals. Computer hackers and other data thieves recognize the potential value of an individual's personal information contained in health-care related files, and are constantly searching for new, vulnerable personal data bearing targets.

Keeping current with complex and dynamic regulations intended to safeguard medical patient information is a time-intensive and often ambiguous undertaking for healthcare staff that may already be challenged with an onerous workload. The HIPAA Security Rule alone includes over 60 components that are measured against over 90 controls established by the National Institute of Standards and Technology (NIST), and these are often both difficult to understand and easily misinterpreted by organization personnel outside of the field. Failure to understand and implement applicable regulations can easily result in non-compliance and a potential breach of protected medical patient data. There are also a range of regulations and laws in that set forth compliance requirements in the privacy and breach sectors including regulation 45 CFR 164 subparts C, E, and D which respectively cover security standards for the protection of EPHI, privacy of individually identifiable health information, and notification in the case of breach of unsecured protected health information.

Compliance failure can occur if: security and privacy assessments are not performed comprehensively, security and privacy assessments are not performed recurrently, corrective actions are not implemented or documented, corrective actions are implemented incorrectly, required policies and processes are not adhered to consistently, the privacy and security laws are misinterpreted, and/or healthcare personnel are not kept abreast of the ever-changing federal and state laws and regulations governing the privacy and security of personally identifiable healthcare information.

There remains a need for a service provided to healthcare clients (Covered Entities and Business Associates) that acts to minimize or eliminate these potential compliance failures relating to host governmental requirements (HIPAA and HITECH Privacy and Security laws and regulations). Furthermore, currently organizations cannot quantify the vulnerability to healthcare information associated with a currently implemented compliance programs as well as the progress of the organization in improving its compliance efforts as well as lessening its vulnerability of healthcare information over time.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein are systems, devices, apparatuses, computer program products and/or computer-implemented methods that facilitate a determination of a maturity level representing a state of compliance and a risk score representing a vulnerability of a set of protected data in accordance with one or more embodiments described herein.

According to an embodiment, a system is provided. The system comprises a processor that executes computer executable components stored in memory. The computer executable components comprise a first determination component that determines a maturity level representing a state of compliance based in part on a comparison of a set of compliance program data or a set of remediation data to a set of requirement data. Furthermore, the computer executable components comprise a scoring component that generates a risk score representing an estimated impact of threat data, vulnerability data, or non-compliance data on a set of protected information data based on a comparison of a first value corresponding to a maturity level to one or more values corresponding to a threshold maturity level, wherein the threshold maturity level is based at least in part on a set of risk criteria.

According to another embodiment, a computer-implemented method is provided. The computer-implemented method can comprise determining, by a system operatively coupled to a processor, a maturity level representing a state of compliance based in part on a comparison of a set of compliance program data or a set of remediation data to a set of requirement data. The computer-implemented method can also comprise generating, by the system, a risk score representing an estimated impact of threat data, vulnerability data, or non-compliance data on a set of protected information data based on a comparison of a first value corresponding to a maturity level to one or more values corresponding to a threshold maturity level, wherein threshold maturity level is based at least in part on a set of risk criteria.

According to yet another embodiment, a computer program product for facilitating a determination of a risk level associated with a compliance program, the computer program product comprising a computer readable storage medium having program instructions embodied therewith, the program instructions executable by a processor to cause the processor to determine a maturity level representing a state of compliance based in part on a comparison of a set of compliance program data or a set of remediation data to a set of requirement data. The computer program product can also cause the processor to generate a risk score representing an estimated impact of threat data, vulnerability data, or non-compliance data on a set of protected information data based on a comparison of a first value corresponding to a maturity level to one or more values corresponding to a threshold maturity level, wherein threshold maturity level is based at least in part on a set of risk criteria.

### BRIEF DESCRIPTION OF THE DRAWINGS

FIG. 1 illustrates a block diagram of an example, non-limiting system that can facilitate a determination of a maturity level representing a state of compliance and a risk score representing a vulnerability of a set of protected data in accordance with one or more embodiments described herein.

FIG. 2 illustrates a block diagram of an example, non-limiting system that can facilitate a determination of one or more values corresponding to the threshold maturity level based on a set of risk criteria in accordance with one or more embodiments described herein.

FIG. 3 illustrates a block diagram of an example, non-limiting system that can facilitate a generation of visual depictions of maturity levels and risk scores in accordance with one or more embodiments described herein.

FIG. 4 illustrates a block diagram of an example, non-limiting system that can facilitate an evaluation of the set of risk criteria in accordance with one or more embodiments described herein.

FIG. 5 illustrates a block diagram of an example, non-limiting system that can facilitate an update of a maturity level or risk score in accordance with one or more embodiments described herein.

FIG. 6 illustrates a block diagram of an example, non-limiting system that can facilitate a prediction in growth of one or more maturity level in accordance with one or more embodiments described herein.

FIG. 7 illustrates a block diagram of an example, non-limiting system that can facilitate a machine learning model to label sets of compliance program data based on a level of similarity amongst compliance program data points in accordance with one or more embodiments described herein.

FIG. 8 illustrates a block diagram of an example, non-limiting system that can facilitate an evaluation of the level of similarity between an input set of compliance program data and the labeled sets of compliance program data based on maturity level similarity criteria or compliance element similarity criteria in accordance with one or more embodiments described herein.

FIG. 9 illustrates a block diagram of an example, non-limiting system that can facilitate a grouping of the intake compliance data into a first labeled set of compliance program data based on a comparison of a similarity value with a similarity level threshold value in accordance with one or more embodiments described herein.

FIG. 10 illustrates a block diagram of an example, non-limiting system that can facilitate an integration of the threat data, the vulnerability data, and the non-compliance data into comprehensive risk data representing an indicator of overall risk in accordance with one or more embodiments described herein.

FIG. 11 illustrates a flow diagram of an example, non-limiting computer-implemented method that facilitates determination of a maturity level representing a state of compliance and a risk score representing a vulnerability of a set of protected data in accordance with one or more embodiments described herein.

FIG. 12 illustrates a flow diagram of an example, non-limiting computer-implemented method that facilitates determination of a maturity level representing a state of compliance and a risk score representing a vulnerability of a set of protected data in accordance with one or more embodiments described herein.

FIG. 13 illustrates a flow diagram of an example, non-limiting computer-implemented method that facilitates determination of a maturity level representing a state of compliance and a risk score representing a vulnerability of a set of protected data in accordance with one or more embodiments described herein.

FIG. 14 illustrates a flow diagram of an example, non-limiting computer-implemented method that facilitates determination of a maturity level representing a state of compliance and a risk score representing a vulnerability of a set of protected data in accordance with one or more embodiments described herein.

FIG. 15 illustrates a flow diagram of an example, non-limiting computer-implemented method that facilitates a configuration of the first device from an application executing on a second device in accordance with one or more embodiments described herein.

FIG. 16 illustrates a block diagram of an example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section. One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

In various respects, a HIPAA covered entity (e.g., user, organization, company, healthcare provider, hospitals, physician providers, pharmacies, long term care organizations, homecare, hospice, laboratories, diagnostic companies or HIPAA business associates (e.g. collection agencies, contractors, cloud-based software providers, and other such organizations) that generates, utilizes, and/or receives, transmits or maintains patient information such as patient health information and electronic patient health information (EPHI) that are governed by laws and regulations that mandate the security and confidentiality of such medical patient information and data. Furthermore, such laws and regulations often change or incorporate new laws by which such entities must comply. For instance, the HIPAA Security Rule, which establishes national standards to protect EPHI and PHI, includes over 60 components and is measured against over 90 controls (e.g., guidelines) established by the National Instituted of Standards and Technology (NIST). The consequences of non-compliance can be severe.

In another aspect, the systems and methods disclosed herein can also be utilized by organizations (including HIPAA covered entities in some instances) subject to subject to privacy and breach regulations such as 45 CFR 164 Subpart C—Security Standards for the Protection of Electronic Protected Health Information, 45 CFR 164 Subpart E—Privacy of Individually Identifiable Health Information, 45 CFR 164 Subpart D—Notification in the Case of Breach of Unsecured Protected Health Information. Such regulations can include privacy rules, notice of privacy practices, patient rights, business associated/relationship management, training, and breach requirements. There are well over 280 policies, procedures, documentation, and other such requirements in the privacy and breach areas that can be addressed by the systems and methods disclosed herein. For example, the system can assess, recommend and track remediation and compliance activities related to privacy and breach areas. Furthermore, in a non-limiting embodiment, system 100 disclosed herein can facilitate a review of over 280 policies, groups comprising several policies, procedures, formats, and logs provided to clients (e.g., during the phase of providing remediation data to clients).

In an aspect, this disclosure includes systems and methods for developing and managing compliance plans, generating remediation plans to improve compliancy shortfalls, and improving upon these capabilities. In an aspect, the disclosed systems and methods can facilitate a quantification of the success of the management and implementation efforts related to a compliance plan and a remediation plan by determining a maturity level of the compliance activities (e.g., policies, tasks, etc.) as compared to the compliance requirements (e.g., rules and regulations). Furthermore, the disclosed systems can determine a risk score that represents and/or quantifies the impact of compliance activities and/or remediation activities on the organization from a risk perspective, the likelihood of occurrence of one or more potential consequences related to one or more risk within the organization, and vulnerabilities associated with the state of riskiness of the organization.

In an aspect, a maturity level can be a metric that identifies the state of achievement of a compliance policy, process, task, operation, and/or activity. In another aspect, a maturity level can be measured by the achievement of a specific and generic goal that applies to a predefined set of policies, processes, implementations, or other such area. For instance, a maturity level can be a measurement of the ability of particular policies, processes, and implementations (of such policies and processes) to satisfy the requirements set forth in an NIST control or HIPAA regulation. As such, the determination of a maturity level corresponding to compliance activities allows for the monitoring, tracking, and quantification of compliance progress. Furthermore, the systems and methods disclosed herein can also quantify a level of risk via a risk score associated with the security of protected data, vulnerabilities to information and organizational assets including protected data, effectiveness and coverage of risk management activities, susceptibility to security and privacy breaches, and likelihood of threats manifesting into breaches.

For instance, a risk score (e.g., indicator of impact, likelihood and vulnerabilities of an organizational compliance status) can represent the risk of an event (e.g., security breach) occurring by an actor (e.g., malicious outsider, malicious insider, etc.) based on a maturity level of a NIST control (e.g., a control that provides guidance on software security standards). Accordingly, the disclosed systems and methods provide for capabilities associated with identifying, quantifying, and determining the state of an organizations compliance and/or remediation activities. Moreover, the disclosed systems and methods provide for technologies that facilitate the continuous reporting and management of security and privacy risks by quantifying maturities of compliance activities and assets as well as quantifying risk on a continuous basis. Furthermore, a client device can identify within a set of controls, the particular control or groups (e.g., family) of controls that have the greatest or lowest impact on risk.

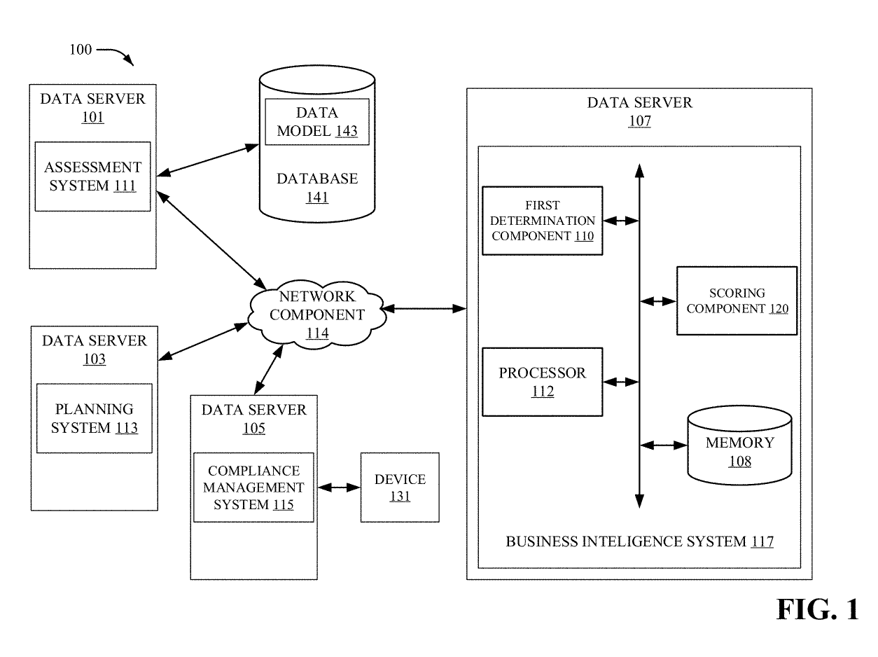

FIG. 1 illustrates a block diagram of an example, non-limiting system 100 that can facilitate a determination of a maturity level representing a state of compliance and a risk score representing a vulnerability of a set of protected data in accordance with one or more embodiments described herein.

In an aspect, system 100 can comprise (first) data server 101, (second) data server 103, (third) data server 105, (fourth) data server 107, device 131, database 141, and/or network 114. In an aspect, data server 101 can include an assessment system 111. In another aspect, database 141 can comprise a data model 143. In yet another aspect, data server 103 can comprise a planning system 113. Furthermore, in an aspect, data server 105 can comprise a compliance management system 115. In another aspect, data server 107 can comprise a business intelligence system 117 that includes a first determination component 110, a scoring component 120, a processor 112, and a memory 108. In an aspect, network 114 can represent a distributed computing environment where tasks are performed by remote processing devices (e.g., data server 101, data server 103, data server 105, data server 107, device 131, database 141, etc.) that are linked through network 114 (e.g., a communication network, cloud-based communication network, etc.). However, in some non-limiting embodiments, aspects of this disclosure can be practiced on stand-alone computers. In some non-limiting embodiments, the disclosed systems can be implemented over a distributed computing environment comprising program modules located in local and/or remote memory storage devices.

In a non-limiting embodiment, system 100 can include a business intelligence system 117 that can utilize client data (e.g., policy data, process data, procedural data, technical structural data, environmental structural data) to facilitate a determination of a maturity level representing a state of compliance and a risk score representing a vulnerability of a set of protected data. In an aspect, business intelligence system 100 can execute (e.g., as an application, system, etc.) on a data server device 107 that employs processor 112 to execute a first determination component 110 that can determine a maturity level representing a state of compliance based in part on a comparison of a set of compliance program requirement data and a set of remediation data to a set of requirement data. In an aspect, a maturity level can indicate a state of compliance achieved in comparison to a requirement (e.g., regulation, rule, law, control, etc.) at a given moment in time by a client or client device (e.g., entity, device, user, organization, etc.). In an aspect, the client or client device can access, receive, generate, manage, store, transmit, and/or utilize client data representing confidential information such as protected health information (PHI) or electronic protected health information (EPHI) that requires such client device to abide by or comply with various rules and regulations.

For instance, a system (e.g., assessment system 111) executing on a client device (e.g., data server 105) corresponding to a covered entity (also referred to as a client) that can access or control PHI or EPHI, can receive input data (e.g., also referred to as client data) and transmit such input data to a data store (e.g., database) for storage. The input data stored at the data store (e.g., data store 141) can include policy data, process data, procedural data, technical structural data, environmental structural data and confidential information (e.g., patient information) such as PHI and EPHI. Furthermore, such input data can also be utilized to facilitate the execution, tracking, monitoring, or identification of activities performed by an organization associated with the client device.

As such, administrative data can represent policies, procedures, and transactional (e.g., contracts) information utilized or proposed for utilization by an organization associated with the client device or organizations associated with client device and capable of accessing PHI and/or EPHI. Furthermore, such administrative data (e.g., a subset of client data) can be compared to relevant host data (e.g., compliance data representing controls, laws, regulations, etc.) stored at a database (e.g., database 141) In an aspect, client data stored at database 141 is stored and processed in accordance with a data model (e.g., data model 143) that organizes and indexes subsets of client data in order to facilitate the assessment of such client data (e.g., using assessment system 111) and the generation (e.g., using assessment system 111) of a customized client compliance plan, generation (e.g., using planning system 113) of a remediation plan associated with such client data, and perform management (e.g., using compliance management system 115) activities related to such client data. In an aspect, the customized client compliance plan can include an identification of compliance items required to comply with governmental requirements based on client objectives. Furthermore, the host compliance data can include data representing government compliance requirements (e.g., laws, regulations, and controls) such as Health Insurance Portability and Accountability Act (HIPAA) regulations, The Health Information Technology for Economic and Clinical Health (HITECH) Act, Privacy and Security compliance laws, National Institute of Standards and Technology (NIST) controls, and other such rules and regulations.

In another aspect, client device (e.g., device 131) corresponding to a covered entity can also utilize, access and/or employ business intelligence system 117 to continuously manage and assess the maturity level data (e.g., representing a maturity level) corresponding to control data and compliance data representing controls and compliance activities. Furthermore, business intelligence system 117 can monitor as well as manage risk data associated with compliance data and non-compliance data representing compliance activities and non-compliance activities of the organization respectively. In an aspect, the maturity level can be impacted by advancements or lack of advancements to compliance activities (and/or remediation activities) of an organization based on an integrated set of compliance data. In an aspect, compliance data representing compliance to a regulation or control can be achieved by changes to policy data, process data, procedural data, technical structural data, and environmental structural data. Furthermore, a change to a particular subset of data (e.g., policy data) can result in a change to another subset of data (e.g., environmental structural data) which requires first determination component 110 to account for all such changes and determine a maturity level based on such changes.

For instance, in a non-limiting example, the installation of a new policy within an organization can result in a change to the organization of physical assets of an organization. As an example, a policy that requires screens of computer terminals within the organization not face towards any windows to protect potential viewing of patient information can result in the change of compliance data (representing enhanced compliancy) as a result to changes in policy data and environmental structure data representing computing assets positioning in the organization. Thus, both the change in policy data and change in physical environment data have contributed to an increase in compliance and a determination (e.g., using first determination component 110) of such increase in compliance translating into a change in maturity can take into account changes to both subsets of data.

Furthermore, many of the activities represented by compliance data are interconnected with other activities represented by other subsets of data, such that a determination of an increase in maturity level occurs based on the totality of maturation of the entire compliance plan as a result of satisfaction of individual integrated compliance items. In another aspect, business intelligence system 117 can execute first determination component 110 to determine the maturity level of one or more compliance activities or assets with respective compliance requirements. For instance, client device (e.g., device 131) can utilize assessment system 111 to generate a portion of a customized client compliance plan to devise a compliance strategy related to client terminal devices (e.g., personal computers) that receive and access PHI. As such, the compliance strategy may include a compliance requirement (e.g., pursuant to an NIST control) that the client terminal device be locatable, securely operated, and implement various privacy protocols.

As a non-limiting example, an organization associated with a client device that utilizes thousands of terminal devices but can only determine the location of five percent (5%) of such terminal devices at a given time complies with the compliance requirement (e.g., requiring identification of all terminal devices of the organization) at a respective maturity level. As such, business intelligence system 117 can utilize compliance data (e.g., terminal device detection data) representing such terminal device information and employs processor 112 to execute first determination component 110 and determine a low maturity level exists based in part on the compliance with such respective NIST control needing significant improvement. In an aspect, the low maturity level can represent a metric that indicates that the organization associated with the client device is implementing an unevolved policy, technology, and/or process to locate and securely operate its terminal devices. However, if the client implements various protocols, systems, detection technologies, and policy requirements (e.g., a requirement to utilize a virtual private network, location tracking systems installed on such terminals, etc.) that result in the organization being able to detect location data corresponding to seventy-five percent (75%) of the terminal devices, then processor 112 can execute first determination component 110 to determine the occurrence of an increase in the maturity level associated with such NIST control requirement. Furthermore, planning system 113 can include a subset of data within the remediation plan that represents a plan for the implementation of such protocols and systems. As such, first determination component 110 can factor in such remediation plan data subset to determine whether an increase in a maturity level related to compliance with such control should occur.

As such, the maturity level can represent a state of compliance based on a comparison of compliance program requirement data such as data representing an NIST control requirement and a set of remediation data (e.g., in the non-limiting example, the remediation data subset represents the ability to detect the location of seventy five percent of its terminal devices after implementation of systems, protocols and requirements) or compliance data (e.g., data representing the original capability of the organization to detect the location of five percent of its terminal devices). As such, a maturity level can be used as a metric to identify a state of current compliance, a metric that enables the monitoring of compliance progression (e.g., determining a change in a maturity level over time or upon the occurrence of various events, etc.), and an overall assessment of a clients' compliance strengths and weaknesses (e.g., maturity level of one control over another control indicates areas of strength and weakness). In an aspect, business intelligence system 117 can execute (e.g., using processor 112) first determination component 110 to determine a maturity level of a regulation (e.g., HIPAA Regulation) and/or control (e.g., NIST control) in isolation, a maturity level of an entire set of regulations and/or control, and/or a maturity level of a family of regulations and/or controls.

For instance, in a non-limiting embodiment, processor 112 can execute first determination component 110 to determine a maturity level of a family of planning (PL) NIST controls such as controls governing security planning policies and procedures, system security plans, system security plan updates, organizational rules or allowable behaviors, privacy impact assessments, security-related activity planning, security concept of operations, information security architecture, and central management. As such, by continuously determining maturity levels of independent controls and several combinatorial groups of controls, first determination component 110 can facilitate a tracking of maturity levels and maturity level improvements that have occurred with respect to a clients' ability to comply with activities associated with an NIST planning control family. In another aspect, first determination component 110 can also determine the maturity level of other NIST and associated HIPAA control policy and procedure families including, but not limited to, access control (AC) family, security awareness and training (AT) family, audit and accountability family (AU), security assessment and authorization (CA) family, configuration management (CM) family, contingency planning (CP) family, identification and authentication (IA) family, incident response (IR) family, maintenance (MA) family, media protection (MP) family, physical and environmental protection (PE) family, personnel security (PS) family, risk assessment (RA) family, system and communications protection (SC) family, system and information integrity (SI), system and services acquisition (SA) family, program management (PM) family, and other such control families.

In another aspect, first determination component 110 can quantify the maturity level (e.g., and express such quantification via maturity level data) of a NIST control in any of several manners, including but not limited to, a percentage of maturation with one hundred percent (100%) being fully mature or as an amount of compliancy conformation (e.g., a family of controls or regulations, an individual control or regulation, the entire set of controls or regulations, etc.) such as fully conforming (e.g., first subset of maturity level data), somewhat conforming (e.g., second subset of maturity level data), partially conforming (e.g., third subset of maturity level data), and/or mostly conforming (e.g., fourth subset of maturity level data). In another aspect, the maturity level can be determined (e.g., using first determination component 110) based on a previous assessment of compliance maturity (e.g., assessing compliance data for maturity level determination) and/or based on a current assessment of a maturity level. Accordingly, a change in maturity level can be determined (e.g., using first determination component 110) based in part on comparisons between previously assessed maturity levels (e.g., subset of previous maturity level data) of control and regulation compliance and current maturity level determinations (e.g., subset of current maturity level data) of such control and regulation compliance.

In yet another aspect, the determined maturity level data can be represented in a range of formats, depictions, and representations including a set of graphical depictions, a set of numerical depictions and a set of textual depictions. Furthermore, in an aspect, maturity level data (e.g., depictions of NIST control maturity) can be displayed as visual representations and in various formats that can include, but is not limited to, a dot plot, a bar chart (e.g., vertical or horizontal), line graph, circle graph, histogram, frequency polygon, radial diagrams, linear diagrams, column diagrams, map diagrams, tree maps (e.g., decision trees), and other such representations. For instance, in an aspect, the x-axis of a bar chart can list respective independent controls such as system security plan (PL-02), wireless access restrictions (AC-18), configuration change control (AT-03), auditable events (AU-02), continuous monitoring (CA-07), and other such independent controls. In another aspect, the y-axis of the bar chart can list percentages of maturity. Furthermore, in an aspect, the bars can be color coded to include a portion of the bar that is a first color (e.g., blue) representing the previous average maturity level of a respective NIST control (or regulation) and a second color (e.g., orange) that represents the improvement in the maturity level (e.g., corresponding to maturity level data) above the previous average maturity level of the respective NIST control. Accordingly, client device can analyze side by side comparisons of discrete maturity levels corresponding to independent maturity levels.

As such, maturity level data can be depicted in various graphic representations generated (e.g., using modeling component 310 described in later embodiments) using business intelligence system 117. In another aspect, maturity level data can represent a quantifiable (e.g., using first determination component 110) value based on various data subsets such as data subsets representing a progress of planning, implementing, and completing a task to comply with various controls and/or regulations. For instance, first determination component 110 can determine whether a compliance task is quantified as a lower maturity level (e.g., represented by a subset of maturity level data) based on whether the implementation of a compliancy task is at the policy stage, procedural stage, implementation stage, test stage, and/or integration stage. For instance, first determination component 110 can utilize policy data associated with a compliancy task that can represent formal up-to-date documented policies that impose obligations on a client (e.g., client employees) to undertake compliancy activities.

Furthermore, in another aspect, a subset of policy data can represent policies that establish continuous risk assessment tasks, risk mitigation implementation tasks, and monitoring tasks to facilitate progress and efficacy of a compliancy program (e.g., program to facilitate compliance with a control and/or regulation). Also, in an aspect, first determination component 110 can determine a maturity level (e.g., represented by determined maturity level data) of a compliancy program, activity, or task based on an evaluation of a subset of policy data and compliance data. In an aspect, policy data can be determined (e.g., using first determination component 110) to be more or less mature based on the quantifiable degree or determined level that such policy data corresponds to policies that facilitate compliance activities within several client facilities and affect operations of a particular asset or operations within at least a part of a clients' organization.

In yet another aspect, determination component 110 can determine a maturity level (e.g., represented by maturity level data) based on the quantifiable degree or determined level by which a subset of policy data represents a delineation of security management structures within a client organization, establishes policies that assign security responsibilities within the clients' organization, establishes policies that are capable of measuring progress and levels of compliance with controls and/or regulations. Furthermore, a determination (e.g., using first determination component 110) of a level of maturity can be based on a quantifiable degree or determined level by which policy data corresponds to policies that identify penalties and/or disciplinary actions that serve as a consequence for non-compliance with established policies.

In another aspect, first determination component 110 can determine a level of maturity that is greater than the first level of maturity and that represents a higher state of compliance based at least in part on an evaluation of procedural data associated with respective compliancy tasks. For instance, first determination component 110 can utilize procedural data to determine and/or quantify a maturity level, where the procedural data corresponds to documented procedures provided to implement security controls identified by defined client policy data. In another aspect, first determination component 110 can determine a second maturity level based on whether procedural data represents details such as where procedures must be performed, how a procedure is to be performed, when a procedure is to be performed, who must perform a procedure, and a specific description of the procedure to be performed. Also, a second maturity level can be determined based on whether procedures corresponding to the procedural data document the implementation of and the rigor in which a control is applied.

In an aspect, first determination component 110 can determine a maturity level by comparing a value associated with a set of compliance data (e.g., compliance value) and/or a set of remediation data (e.g., remediation value) to a value associated with a set of requirement data (e.g., requirement value). For instance, a subset of requirement data can include elements of NIST control PL-02 which requires a development of a security plan for an information system that meets a set of criteria (e.g., plan describes security controls in place, identifies relevant overlays, etc.). In an aspect, first determination component 110 can determine a maturity level of a subset of compliance data based on the ability of such compliance data to conform to the requirements set forth in NIST control PL-02.

Thus, in an instance, if the client currently has no security plan in place then first determination component 110 may determine that a low value (e.g., immature) is to be assigned as a maturity level to the subset of compliance data. However, a client with a security plan that lacks several details but is thorough in several isolated respective areas may be determined to have a slightly higher value as the maturity level of such subset of compliance data indicating the presence of improved compliance attributes. Furthermore, first determination component 110 can also utilize remediation data in its determining a maturity level based on compliance associated with requirement data. For instance, the client with a subset of compliance data that is determined to have maturity level data corresponding to a partially mature status may also have recently implemented several remediation activities to bolster its security plan and provide a more robust set of details in other areas not previously covered. As such, first determination component 110 may utilize the subset of compliance data and the subset of remediation data to determine that the maturity level of such subsets of data in aggregate generate a higher data value than the determination based only on the compliance data presented, and such higher data value can represent a maturity level greater than a partially mature status for compliance activities associated with the PL-02 control.

In another aspect, first determination component 110 can utilize implementation data to determine whether a compliance program is more mature (e.g., having a higher maturity level) or less mature (e.g., having a lower maturity level) amongst a range of maturity states (e.g., immature state to fully mature state). As such, first determination component 110 can determine a maturity level based at least in part on implementation data that represents information associated with the implementation of established policies within the clients' organization. For instance, implementation data can contribute to a determination of maturity in compliancy activities based on whether such data represents information that facilitates a greater or lesser capacity for procedures (e.g., compliancy procedures) to be communicated to individuals or stakeholders (e.g., asset owners, users, patients, information resource management personnel, security administrators, etc.) required to follow such procedures. Also, in an aspect, first determination component 110 can utilize implementation data to determine the level of consistency by which applicable compliancy procedures are implemented throughout an organization and the degree to which, if any, such implementation data is reinforced via training.

In another aspect, first determination component 110 can utilize implementation data to determine whether a compliance program tends to be implemented on an individual or ad hoc basis versus a continual basis to determine a maturity level. In an instance, a higher maturity level can be determined based on implementation data representing an implementation of a security regimen that is continuously implemented and monitored rather than a security regimen that is implemented on a case-by case basis. In yet another aspect, first determination component 110 can determine whether a compliance program is more or less mature based on implementation data that indicates initial testing is performed on a security or compliancy program implementation to ensure a compliance activity is operating to satisfy the requirements of a control. Furthermore, in an aspect, a maturity level can be determined based at least in part on whether procedures (e.g., represented by procedural data), policies (e.g., represented by policy data), and implementation of such policies and procedures are approved by key personnel (e.g., those affected by such policies and procedures).

Furthermore, in another aspect, first determination component 110 can utilize test data to contribute to a determination of a maturity level of a compliancy policy, program, procedure, and/or activity. Accordingly, test data can represent information, attributes or test activities that indicate whether an organization has a greater or lesser maturity based on its ability to perform activities to evaluate the adequacy and effectiveness of policy data corresponding to established policies (e.g., policy specificity, policy content, policy coverage, etc.), procedural data corresponding to compliancy procedures (e.g., fit of a procedure to compliancy requirement, etc.), implementation data corresponding to the implementation of policies and procedures (e.g., efficacy of implementation of policies and procedures, etc.). In another aspect, first determination component 110 can determine a maturity level of a compliancy activity based, at least in part, on the client organizations test data. In an instance test data can represent the presence and degree of efficacy of testing mechanisms to ensure that all policies, procedures, and controls are achieving intended results (e.g., achieving appropriate security levels).

Furthermore, in an aspect, first determination component 110 can determine a maturity level based in part on whether the test data also represents testing mechanisms that identify corrective actions related to weaknesses in current policies, procedures, and implementations of a clients' operations. For instance, first determination component 110 can determine whether the test data addresses potential or actual security breaches or security notifications triggered within the organization or by organizational affiliates (e.g., vendors, government agencies, trusted sources, etc.). In yet another aspect, first determination component 110 can determine a maturity level based in part on whether test data indicates the occurrence of routine self assessments that evaluate the adequacy and efficacy of implementation data corresponding to various implementation activities (e.g., implementation of policies, procedures, controls, etc.). Furthermore, in an aspect, business intelligence system 117 can execute (e.g., using processor 112) first determination component 110 to determine a maturity level based in part on whether test data indicates the occurrence of independent audits that assess the clients' performance. For instance, test data that indicates that clients' organization obtains routine security audits from government agencies (e.g., General Accounting Office, Inspector General) may be determined (e.g., using first determination component 110) to have a greater maturity level than test data that indicates a client organization obtains no audits or performs only internal management audits.

In yet another aspect, first determination component 110 can determine a maturity level based in part on a determination of whether client test data represents test results that identify vulnerabilities, insights into threats (e.g., potential security and/or privacy breaches), and/or risks to the security of client systems and information. Furthermore, first determination component 110 can evaluate test data based on factors such as the frequency by which test data is generated (e.g., how often tests are conducted), the detail and thoroughness of testing documentation, the degree to which testing activities are approved and the efficacy by which the testing activities are implemented. Also, in an aspect, first determination component 110 can determine a maturity level based on a determination of the frequency and rigor by which independent controls and groups of controls are tested.

Furthermore, in another aspect, first determination component 110 can determine a maturity level of a compliancy policy (e.g., evaluating policy data), program (e.g., evaluating program data), procedure (e.g., evaluating procedural data), and/or activity based in part on integration data. In an aspect, integration data can represent the integration of various client operations, activities, compliance tasks, procedures, policies, technology implementations, tests or other such areas related to a holistic client compliance plan. Furthermore, many of the areas of compliance are comprised of multidisciplinary requirements. For instance, a policy or procedure may require the implementation of a technology within the organization. As such, the drafting and implementation of a policy requirement may also satisfy compliance requirements related to technology implementations. Furthermore, in another non-limiting instance, the implementation of a new technology may bring to light new compliance requirements related to policies addressing use of such technologies and processes governing the use of such new technologies. Thus, first determination component 110 can utilize integration data to determine a total maturity (or individual maturities) of the compliance program based on the interconnectedness of the numerous data subsets associated with compliance activities.

As such, in an aspect, first determination component 110 can determine a maturity level of a compliance activity based on its integral effect on other compliance activities and importance to the effective functioning of the entire compliance program. In another aspect, first determination component 110 can determine a maturity level of a compliance activity based in part on integration data. As such, a maturity level of a compliance activity can convey information as to the impact of such control on cost and risk, but also on the maturity level of a group of compliance activities and client missions. Furthermore, in other aspects, a maturity level can indicate whether threats are continually reevaluated, controls are adapted to changing security environments, policy and procedural alternatives are identified when making decisions, costs and benefits of implementing respective activities are measured, and status metrics are established and satisfied within a client organization in order to satisfy compliance requirements.

As such, business intelligence system 117 can employ processor 112 to execute first determination component 110 to determine a maturity level associated with a state of compliance of a client as compared to particular regulations, and requirements in various verticals (e.g., privacy, security, etc.). In another aspect, business intelligence system 117 can employ processor 112 to execute scoring component 120 that generates a risk score representing an estimated impact of threat data, vulnerability data, or non-compliance data on a set of protected information data based on a comparison between a first value corresponding to maturity level data (e.g., representing a maturity level of compliance activities) to one or more values corresponding to a threshold maturity level, wherein the threshold maturity level is based at least in part on a set of risk criteria.

In an instance, a risk score can be a quantified representation of the impact on the organization of various risky events occurring due to the presence of a given maturity level of compliance activities as well as non-compliance related impact factors. In an aspect, a risk score can indicate a vulnerability of a set of protected data based on a comparison of the maturity level to a threshold maturity level. In an aspect, the maturity level represents a quantifiable metric of compliancy associated with compliance programs and tasks associated with a compliance requirement (e.g., regulation, policy, law, control, etc.). Also, in an aspect, a maturity level threshold can represent a level of maturity (e.g., represented by a data value) that indicates the presence of a certain exposure to risks from non-compliance and compliance related impact factors. Accordingly, the comparison of the maturity level (e.g., data value) to the threshold maturity level (e.g., threshold data value) can facilitate the generation of a risk score, where the threshold maturity level provided a risk adjusted scale to allow for the determination of riskiness to an organization given a certain maturity level (e.g., data value).

In another aspect, a risk score (e.g., represented by risk score data) can be an indicator of a clients' ability to identify, assess and mitigate risk in various areas (e.g., security risks, privacy risks, etc.) of its organization. In an aspect, the risk score can be generated (e.g., using scoring component 120) by comparing the determined (e.g., using first determination component 110) maturity level (e.g., a data value associated with the determined maturity level) to a threshold maturity level (e.g., a data value associated with the threshold maturity level). For instance, a determined maturity level can correspond to a value of three based on its ability to facilitate and bring about precise and accurate compliance acts that satisfy the requirements of a control and/or regulation. As such, a threshold maturity level can be determined to be a level one maturity (e.g., low maturity) if a maturity level is between a value of one and five, furthermore, a level two maturity can correspond to determined maturities greater than or equal to a threshold data value of five but less than a threshold data value of ten. Accordingly, a maturity level can be determined (e.g., using first determination component 110) based on a comparison of compliancy factors to compliancy requirements. Furthermore, the determined maturity level can be compared to a threshold value corresponding to a determined quantification of compliancy to a value or range of values associated with a threshold maturity level.

The threshold maturity level can be determined (e.g., using first determination component 110) to be a particular value based on a set of risk factors such as the degree of risk undertaken by an organization/covered entity and its alignment with a compliancy program, a level of increased risk incurred by responding to decisions, a level of exposure to operational surprises and losses, a capability to manage many risks across the clients' enterprise, the establishment of objectives to mitigate risk, the presence of resources and technologies that mitigate risk, and other such risk factors. In an aspect, an organization with a lower maturity level will likely be determined (e.g., using scoring component 120) to have a higher risk score representing the presence of an increased exposure to risk to the clients' organization. Furthermore, an organization with a compliancy program determined to have a greater maturity level can likely have a lower risk score representing a decreased vulnerability to risk based on the compliancy program.

In an aspect, a customized compliance plan generated by assessment system 111 can be implemented within an organization to mitigate risk to organizational operations, assets, personnel, and confidential information and data. However, the implementation of such customized compliance plan implicitly identifies the presence of risks within an organization and scoring component 120 can generate a risk score to represent such risk. For instance, a client that manages information system accounts may face several compliance-related and non-compliance related risks when performing operational activities such as identifying account types, establishing conditions for membership to a client product or service, identifying authorized users of information systems, specifying access privileges for respective authorized users, requiring appropriate approvals for requests to establish accounts, originating or manipulating accounts (e.g., establishing, activating, modifying, disabling, and/or removing accounts), monitoring the use of guest or temporary accounts, deactivating accounts, granting access to terminated users, reviewing accounts, and performing other such activities.

Accordingly, scoring component 210 can generate a risk score that reflects the risks associated with the management information system accounts along with the state of maturity of policies, processes, and activities in place that relate to such risks. Thus, in a non-limiting embodiment, system 100 can facilitate the generation (e.g., using scoring component 120) in connection with the performance of various operations using several devices (e.g., data server 101, database 141, data server 103, data server 104, device 131, data server 107) and/or systems and system components (e.g., assessment system 111, planning system 113, compliance management system 115, business intelligence system 117). Furthermore, in an aspect, scoring component 120 can generate a risk score associated with the in-place compliance programs (e.g., compliance program data), current and future remediation plans (e.g., remediation plan data) and strategies for implementation, and associated maturity levels with such tasks (e.g., task data), policies (e.g., policy data), implementations (e.g., implementation data), processes (e.g., process data), and other such activities performed by the client. The risk score can indicate the vulnerability of the clients' current services, programs, operations, and assets to threats capable of compromising such client assets and activities.

In another aspect, system 100 can employ various devices and systems to facilitate a generation of a risk score in connection with scoring component 120. In an aspect, system 100 can include data server 101 that employs assessment system 111. In an aspect, data server 101 can include a client server model or a multi-tier model (e.g., client, middle tier server, data server, etc.), amongst other models. Furthermore, in an aspect, data server 101 can include hardware and/or software (e.g., threads, processes, computing devices, etc.). The data server 101 can host threads to perform transformations of data sets, data subsets or data points. In an aspect, data store 141 can be a repository for storing and managing collections of data including host data and client data. In an instance, data store 141 can store client data and/or host data and such data can be transmitted from a host compliance data store (e.g., host compliance database not illustrated in FIG. 1) and/or a client compliance data store (e.g., client compliance database not illustrated in FIG. 1).

Furthermore, in an aspect, client data (e.g., also referred to as client compliance data) can represent information related to a currently implemented compliance program within a client organization where such data can relate to client goals, tasks, operations, activities, and plans to meet compliance requirements. Accordingly, in an aspect, client data can include information associated with client security protocols, procedures, and policies. In another aspect, host data (e.g., also referred to as host compliance data) can include information related to government laws, regulations, security controls, privacy controls, best practices, compliance standards and other compliance requirements. As such, data store 141 can store several data sets including host data and client data. In another aspect, data store 141 can store data in accordance with data model 143. A data model 143 can be a system employed by data store 141 that executes (e.g., using a processor) organizational tasks to manipulate, compartmentalize (e.g., using databases) and integrate aspects of stored client data and host data including structured and/or unstructured data. In an aspect, data model 143 can include any one or more technology model components such as conceptual data model components, logical data model components, and/or physical data model components.

In an aspect, the organizational framework (e.g., in accordance with data model 143) of data stored at data store 141 facilitates the performance of assessment, planning, and management operations by assessment system 111, planning system 113, and compliance management system 115 respectively. Accordingly, the assortment of data within data store 141 can be organized within categories, sub-categories metadata, contextual data, content data frameworks, portal data frameworks and other such data classifications. As such, other devices such as data server 101 can utilize such organized data to perform various operations. For instance, assessment system 111 can be employed by data server 101 in a network environment to receive client data and host data from data store 141 and perform assessment activities on such data.

In an aspect, assessment system 111 (e.g., including a processor and a memory not illustrated in FIG. 1) can execute assessment operations to evaluate client data and a current compliance plan and generate a customized compliance plan based on the client data, host data, client goals, and client objectives. In an aspect, the current compliance plan can include client data corresponding to current tasks, operations, policies, procedures, and activities implemented by the client to attempt to meet compliance requirements such as security and privacy requirements. For instance, data store 141 can utilize a data model 143 that classifies data within data subsets that represent policies, processes, procedures, and technical and environmental structures associated with the clients' current organization and affiliated organizations with access to protected health information.

Furthermore, in an aspect, data model 143 can assign tag data and/or reference identification data to client data and/or host data to indicate one or more categorical associations with such data to facilitate assessment, planning, and management operations. For instance, a first subset of data can be assigned first tag data associated with an organizational policy and a second subset of data can be assigned second tag data associated with an organizational procedure to fulfill a policy requirement. Accordingly, in an aspect, assessment system 111 can utilize client data corresponding to the current compliance plan as input data to generate a customized client compliance plan that identifies missing and/or deficient items (e.g., operations, policies, processes, implementation, resources, safeguards, personnel, etc.) needed for compliance with compliance requirements.

In an aspect, assessment system 111 can gather and retrieve client data and host data from data store 141 to compare various subsets of client data to host data for use in generating a customized compliance plan. In an aspect, assessment system 111 can identify deficiencies between the client data representing current policies and procedures as compared to customized policies and procedures that meet regulatory requirements as well as targeted client objectives. As such, assessment system 111 can assess client data by accessing such data and comparing such data within various client operational areas. For instance, assessment system 111 can compare client administrative data to host administrative data. In an aspect, client administrative data can represent information relating to policies, procedures, contracts, and training items within clients' organization. Furthermore, host administrative data can correspond to rules, laws, regulations, and requirements governing or proscribing standards for policies, procedures, contracts and training items within an organization.

As such, assessment system 111 can generate elements of a customized compliance plan that addresses the gap between the client administrative data as compared to requirements set forth within host administrative data. Furthermore, in an aspect, assessment system 111 can receive data from data store 141 that is organized in accordance with client administrative data flows in order to capture all relevant client administrative data. For instance, if the client conducts various processes to approve or modify policies such as the relevant policy data being reviewed and modified by various levels of personnel (e.g., management, committees, etc.) then such client administrative data can be organized in accordance with its administrative process data flow such that assessment system 111 can gather (e.g., from data store 141), group, and/or assess client administrative data in an efficient and expedient manner. In an aspect, such assessment can provide an overview into the capability of the client to assure confidentiality, integrity and availability of data (e.g., protected health information).

As such, assessment system 111 can also generate elements of a customized compliance plan that address the compliance gap and compliance deficiencies between the client technical data, client physical data, and client process data as compared to requirements set forth within rules, regulations and controls represented by host technical data, host physical data, and host process data respectively. In an aspect, client technical data represents information relating to the technical environment, vulnerability scans, technology tools, and configuration information associated with a clients' (e.g., client device) organization. Also, in an aspect, host technical data corresponds to rules, laws, regulations, and requirements governing or proscribing standards for the technical environment, vulnerability scans, technology tools, and configuration information associated with the clients' organization.

In a non-limiting example, the customized compliance plan can assess the technical environment for homogeneity or heterogeneity of environmental components, a degree of stability or variability to the environment, a degree of threat to the security of the technical environment, degree of interconnectedness or isolation amongst environmental elements, degree of coordination or non-coordination amongst environmental elements, availability of resources within a technical environmental, and/or the degree of concentration or dispersion of resources within an environment. Accordingly, the results of such assessment can provide an understanding of deficiencies within the client technical environment. In another aspect, first determination component 110 can utilize such client data and assessment data (e.g., from assessment system 111) to determine a maturity level of the compliance activity with a compliance requirement. For instance, first determination component 110 can compare the client data and assessment data corresponding to elements of the client technical environment and compare such data to an NIST control that addresses the best practices for providing a highest standard technical environment to identify the maturity level of such client compliance operation.

In an aspect, first determination component 110 can determine a maturity level of a subset of data associated with an independent client operation such as the maturity level associated with client vulnerability scan operations as compared to regulations and compliance requirements associated with clients' vulnerability operations. However, first determination component 110 can determine a maturity level of a group or family of client operations as compared to a group of regulations such as the maturity level of administrative data, technical data, physical data or process data as relates to a group of administrative operations (e.g., administrative flow data), technical data operations (e.g., technical flow data), physical data operations (e.g., physical flow data), or process data operations (e.g., process flow data). Also, in an aspect, first determination component 110 can determine a maturity level of several families of data subsets as compared to several subsets of compliance requirements.

As such, first determination component 110 can determine a maturity level that depicts an organizations completion of an operation, task, specific goal or objective that may be an individual element of a larger outcome (e.g., implementation of a policy). Furthermore, any of several maturity levels corresponding to a range of client data subsets can be generated and/or updated to determine the effectiveness of a client to produce a decided, decisive or desired effect capable of producing a targeted result (e.g., safeguarding protected health data, precluding privacy breaches, etc.). Furthermore, the first determination component 110 can determine a maturity level that represents the extent to which an outcome of an operation, task, policy, process and/or activity achieves a targeted objective (e.g., set forth by the client and/or regulations).

Thus, for instance, first determination component 110 can determine a low maturity level of a subset of compliance activities based on assessment data and client vulnerability scan data, however, first determination component 110 can determine a high maturity level for a family of client operations associated with technical data operations including vulnerability scan data. In a non-limiting instance, first determination component 110 can determine a low maturity level representing a lack of compliant processes and systems in place. Furthermore, a determination of the presence of a slightly higher maturity level (as compared to the low maturity level) or emerging maturity level can represent an existence of a minimum level of compliance within a client organization, however, the compliance mechanisms may be inflexible and rigid (e.g., cannot accommodate changes or security problems that arise).

Furthermore, a determination of a medium level of compliance of one or more data subsets can represent the presence of an evolving compliance program capable of managing some client risks. For instance, such evolving maturity level can indicate that planning operations are in place, the client processes and policies are sufficiently flexible to learn from best practices, and the elements of a client compliance plan are integrated with respective operational activities as indicated by operational flow data. A determination (e.g., using first determination component 110) of a high maturity level can represent a maximum flexibility of client compliance activities (e.g., as indicated by a subset of client data) and tasks are planned and coordinated efficiently allowing the client to maximize budgeted resources. Accordingly, first determination component 110 executing on data server 107 can access client data from assessment system 111 to determine a maturity level of such client data as compared to host data received from assessment system 111.

In another aspect, client physical data can represent data relating to the physical controls of the client organization such as data corresponding to the location of device screens or monitors with the clients' organization or the presence or degree of security associated with accessing secure locations within the client organization. The client physical data can be assessed against host physical data that corresponds to rules, laws, regulations, and requirements governing or proscribing standards for the physical controls of the clients' organization. In yet another aspect, client process data can represent data relating to the description of processes associated with the collection, storage, and transmission of PHI. Accordingly, such client process data can be compared to host process data that can represent rules, laws, regulations, and requirements governing or proscribing standards for the collection, storage, and transmission of PHI.

In yet another aspect, assessment system 111 can generate a customized compliance plan that includes client compliance items required to comply with compliance requirements based on the clients' objectives and based on a comparison of the client data to the host data (e.g., from data store 141). Furthermore, system 100 can include data server 103 that executes planning system 113 to generate a client remediation plan to include, at least in part, a prioritized track list of recommendations for improved security and privacy compliancy based on client compliance data corresponding to the client compliance plan generated by assessment system 111. Furthermore, in an aspect, a compliance with higher priority items can indicate a higher maturity level in some instances. As such, the client compliancy data can be transmitted to planning system 113 and evaluated based on raw scoring of client compliance data. Furthermore, planning system 113 can be configured to generate a set of remediation data in response to a state of compliance associated with the compliance data. In an aspect, planning system 113 can adjust the scores associated with the client compliance data to achieve an increased state of compliance as compared to the current state of compliance.

Accordingly, planning system 113 can generate a remediation plan comprising remediation data representing tasks, operations, procedures, policies, and/or activities for implementation within a client organization in order to mitigate deficiencies in compliance identified in the customized compliance plan. In an aspect, the client remediation plan can include assessment snapshot data, risk profile data, peer report data, regulation fulfillment scores, control fulfillment scores, and/or a timeline for achievement of the remediation plan tasks. In another aspect, first determination component 110 executing on data server 107 can access remediation data for use in determining a maturity level associated with respective compliancy with current objectives, goals, regulations, requirements, and/or controls. As such, first determination component 110 can determine a maturity level (e.g., corresponding to generated maturity level data) associated with remediation data independently, compliance data independently, and/or an aggregate of remediation data and compliance data as compared to host data.

Accordingly, data server 107 executing business intelligence system 117 components can access and/or receive client data, host data, compliance data, remediation data and other such data sets and subsets from assessment system 111, planning system 113, and compliance management system 115 in order to determine a maturity level associated with such data subset or combinations of independent data subsets. In another aspect, compliance management system 115 executing on data server 105 can allow for access of a client device (e.g., device 131) or provider device (e.g., device 131) to access and/or manage the customized compliance plan, remediation plan, and/or update information and/or data associated with the customized compliance plan and/or remediation plan. In an aspect, management system 115 can allow for the device 131 to access (e.g., using assessment system 111) assessment snapshot views, detailed analysis data and summary data corresponding to the customized compliance plan and/or remediation plan, and/or assessments of risk associated with current activities, tasks, policies, and/or procedures.

Furthermore, in an aspect, first determination component 110 can access and utilize subsets of data associated with the updated data input by compliance management system 115 in order to update maturity level determinations. In another aspect, scoring component 120 can utilize maturity level data to assign a subset of risk score data to such determined maturity level data. The assigned score data can be based on a comparison of the maturity level data to threshold maturity level data. As such, scoring component 120 can assign a risk score to a subset of maturity level data based on whether such data is greater than or lower than a threshold maturity level. In an aspect, the threshold maturity level can be based on a number of factors such as the categories of input variables utilized to determine the maturity level.

For instance, a first set of maturity level thresholds can be utilized by scoring component 120 for determination of a first risk score associated with client administrative data, a second set of maturity level thresholds can be utilized to determine second risk scores associated with client technical data, a third set of maturity level thresholds can be utilized to determine third risk scores associated with client physical data, and a fourth set of maturity level thresholds can be utilized to determine fourth risk scores associated with client process data. In an instance, the maturity level thresholds can be predetermined based on the type of host data (e.g., regulations, rules, and control) utilized for comparative purposes with particular client data. Thus, a first maturity value of a first maturity level corresponding to a comparison between a first subset of client administrative data and a first subset of host administrative data can compare the first maturity level to a second threshold value that is greater than zero or less than or equal to three, where the first threshold value represents a somewhat conforming operation. Furthermore, a first maturity level value can be compared to a third threshold value that is between a value of four and less than or equal to six represents a partially conforming first maturity level. In another aspect, a first maturity level value can be compared to a fourth threshold value that is between a value of seven and less than or equal to eight represents a mostly conforming first maturity level. Also a first maturity level value can be compared to a fifth threshold value that is between a value of nine and less than or equal to ten which represents a fully conforming first maturity level. Also, a first maturity level value that is equal to a first threshold value of zero represents a non-conforming activity.

As such, a maturity level that equals a first threshold value of zero can indicate that clients' administrative data (e.g., or other data such as policy data, process data, etc.) are unorganized, potentially unstructured, and utilized within non-repeatable or undefined processes. Furthermore, a level of maturity that falls within the second threshold value may indicate that information security efforts are at a repeatable level and processes are being established, defined and documented. In another aspect, the maturity level that falls within the third threshold value may indicate that information security efforts have stronger characteristics within documentation, standardization, and maintenance. In an aspect, the maturity level that falls within the fourth threshold value may indicate that information security efforts have stronger elements of documentation, standardization, and recurring maintenance. In yet another aspect, the maturity level that falls within the fifth threshold value range may indicate that information security processes are constantly improved through monitoring feedback from existing processes and introducing new processes to better serve the clients' organizational goals, objectives, and particular needs. As such, the determination (e.g., using scoring component 120) of respective risk scores can indicate a client-specific vulnerability to particular security or privacy risks from various perspectives (e.g., policy, procedural, technical, etc.).

Furthermore, in an aspect, the maturity thresholds (e.g., range of values) can be different for a second subset of client administrative data compared to a second subset of host administrative data. As such, maturity threshold values can be adjusted to determine an appropriate risk score based on the subset of client data and associated variable as compared to the particular subset of host data and associated requirement attributes. In an aspect, the risk score can represent the impact of the occurrence of various risk events associated with risks exposed to the client organization from compliance deficiencies and other non-compliance related factors. In an aspect, a risk can include the risk that confidential information (e.g., EPHI) can be compromised, accessed, stolen, and breached. Furthermore, a risk score can represent the risk that client systems, resources, and assets can be breached or compromised. As such scoring component 120 can generate a risk score to quantify a level of risk in several security areas such as physical safeguards, administrative safeguards, technical safeguards, policies safeguards, procedural safeguards, and the presence of organizational requirements to provide security protocols.

In an aspect, processor 112 can execute scoring component 120 to generate an overall risk score that can represent an overall level of risk based on the total maturity of the client's compliance program as well as determining risk scores associated with independent maturity levels of various compliance activities and client attributes. For instance, first determination component 110 can determine a maturity level of client physical data by comparing client data related to the facilities and places where patient data is accessed and evaluating computer technologies (e.g., portable devices) utilized to store, access, and generate data. In another aspect, scoring component 120 can determine a risk score based on a comparison of the maturity level to a set of maturity thresholds representing risk scores based on details related to client alarm system data, client locking capability data, ability to view client device screens by unauthorized users, and other such potential security measures undertaken. The maturity thresholds can be determined (e.g., using scoring component 120) based on a determination of attributes that indicate the existence of lesser or greater degrees of security strengths (as opposed to merely compliance with regulations and requirements.

As such, first determination component 110 can determine a maturity based on the capability of a client compliance program and/or remediation program to satisfy compliance requirements of an organization. Furthermore, scoring component 120 can generate a risk score associated with the level of risk or vulnerability of an organization to security threats based in part on the maturity level of the organizations compliance program but also based on the qualitative attributes and features that directly correlate to the presence of strong security undertakings by the organization. For instance, a client can fully comply with physical safeguard requirements, but utilize a vendor alarm system that is susceptible to hacking and such may be determined (e.g., using scoring component 120) to have a lower risk score than an organization that utilizes a vendor with no track record of hacked alarm system instances and offering extra features to prevent such activities. As such, in some instances, first determination component 110 can determine the occurrence of a dramatic change in maturity level that can indicate a slight change in risk score of an organization. Furthermore, in another instance, first determination component 110 can determine the occurrence of a slight change in maturity level by a client that can indicate a dramatic change in risk score to the client.

As such, a maturity level can represent an internal or external conformation to a rule, such as a specification, policy, standard or law. Furthermore, the regulatory compliance describes the goal that the client aspires to achieve and steps to undertake in order to comply with relevant laws and regulations. Furthermore, while a risk score can consider the conformational aspects of a maturity level, the risk score can also represent data associated with internal risks, external risks, corporate strategy, and firm culture. In an instance, a risk score can represent the vulnerability of secure information in all forms (e.g., electronic, physical, etc.) and the security of systems and networks where information is stored, accessed, processed and transmitted within a client organization. As such, a risk score can quantify the impact of compliance factors, controls, threats, assets, and impact factors (e.g., likelihood a threat actor will exploit a given vulnerability) on the clients' organization.

In yet another aspect, network 114 can include hardware and software elements that facilitate in the transmission of data among several devices. In an aspect, network 114 can include a specialized computer system that may be utilized for processing large amounts of data. In an aspect, each device (e.g., data server 101, data store 141, data server 107, data server 103, data server 105, device 131, etc.) system (e.g., data model 143, assessment system 111, planning system 113, compliance management system 115, business intelligence system 117), and system component can communicate with network 114. For instance, each device can transmit data, receive data, process data, transmit signals to network 114. Furthermore, each device communicating with the network can include the use of a model between a host device and a client device that enables convenient, globally accessible, and on-demand access to a pool of computing resources capable of configuration to the needs of the client device. Furthermore, the computing resources (e.g., networks, services, applications, systems, storage devices, servers, etc.) can be rapidly provided to client devices and managed by host devices (and client devices) in expedient and efficient manners.

In an aspect, network 114 can comprise characteristics such as an on-demand self-service aspect that allows the client to automatically without human intervention utilize server time or interact with the service provider (e.g., host). For instance, the client device can access, modify, and update the compliance plan and remediation plan at all times. Network 114 can also provide broad network access through a standard mechanism to promote the use of several devices within the network (e.g., mobile phones, tablets, laptops and workstations). As such, a client device can be any of several devices that can access the customized compliance plan and remediation plan as well as view maturity levels and risk scores. Also, network 114 can include pooled resources with different physical and virtual resources that are dynamically utilized based on client demands.

Furthermore, network 114 can include elastic capabilities to inwardly or outwardly scale capabilities as needed. For instance, if new client data subsets are added to the system in large amounts, network 114 can provide access to several additional storage devices to accommodate the storage needs. In another aspect, a measured service can include the capability to control and optimize resources usage by monitoring, controlled, and reported transactions amongst the network 114 components. In yet another aspect, service models associated with network 114 can include software as a service, platform as a service and infrastructure as a service. In another aspect, the software systems such as business intelligence system 117 can be deployed over a private cloud, community cloud, public cloud, and/or hybrid cloud.

In an aspect, network 114 can include a cloud computing environment comprising one or more cloud computing nodes that allow for communication with devices such as a mobile phone, desktop computer, laptop computer, personal digital assistant, set top box, automobile computer system and other such systems. In another aspect the cloud computing environment can include one or more layers of abstraction, one or more layers of hardware and software, one or more virtualization layer (e.g., virtual servers, virtual storage, virtual networks, etc.), one or more management layer (e.g., to manage the infrastructure of network 114), and one or more workload layers. In an aspect, the workload layer can provide several workloads and functions within a network 114 cloud computing environment including the analysis of data, processing of transactions, management of client data and host data, mapping of data and navigation to data, quantification and determination of maturity levels (e.g., associated with client activities, policies, procedures, etc.), quantification and determination of risk scores (e.g., associated with client activities, policies, procedures, etc.), generation of customized compliance plans, generation of remediation plans, updating of plans and data.

In yet another aspect, system 100 can facilitate a continual assessment of the compliance status of an organization at any given moment in time in addition to continuously determining a maturity level or risk score of the organization in relation to the compliance status. For instance, while system 100 can facilitate an annual audit of the organization's compliance activities that includes a third party verifying the compliance activities and compliance status of an organization based on an evaluation of the data, physical evaluations of the organization, and interactions with key personnel, system 100 can also allow for a non-intervention based assessment of the compliance status of the organization at any given moment in time. For instance, system 100 can utilize new input data and updated input data to provide a current and up-to-date assessment of the compliance of the organization at any given time. Furthermore, system 100 can also provide a maturity level or risk score of the organization at any given moment in time based on the most up to date information as well. As such, system 100 can continually assess the compliance status of an organization (based on new data and input data) as well maturity levels and risk scores in real time.

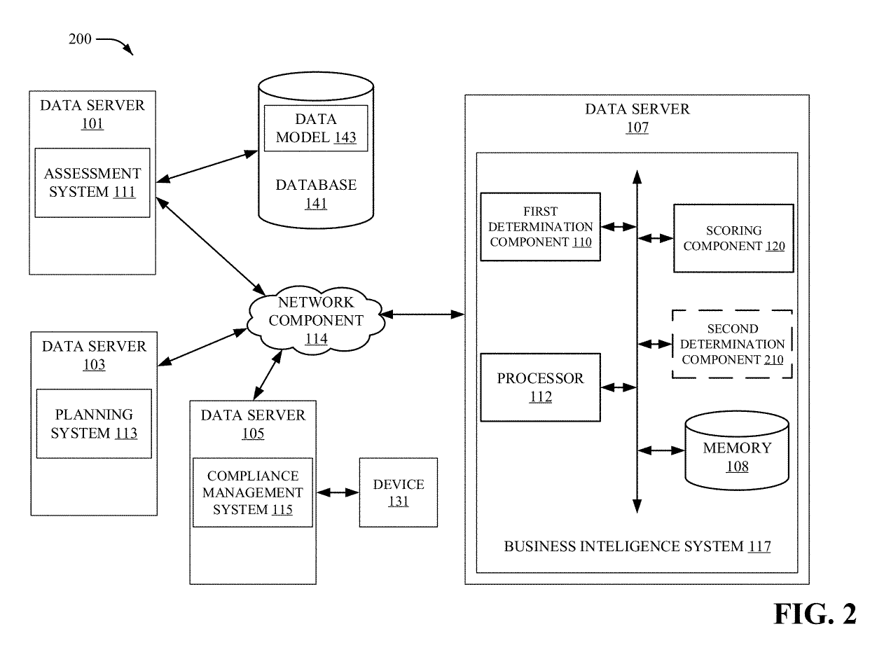

Turning now to FIG. 2, illustrated is a block diagram of an example, non-limiting system 200 that can facilitate a determination of one or more values corresponding to the threshold maturity level based on a set of risk criteria in accordance with one or more embodiments described herein. Repetitive description of like elements employed in other embodiments described herein is omitted for sake of brevity.

In an aspect, system 200 can comprise data server 101, data server 103, data server 105, data server 107, device 131, and database 141, and/or network 114. In an aspect, data server 101 can include an assessment system 111. In another aspect, database 141 can comprise a data model 143. In yet another aspect, data server 103 can comprise a planning system 113. Furthermore, in an aspect, data server 105 can comprise a compliance management system 115. In another aspect, data server 107 can comprise a business intelligence system 117 that includes a first determination component 110, a scoring component 120, a processor 112, and a memory 108. In an aspect, network 114 can represent a distributed computing environment where tasks are performed by remote processing devices (e.g., data server 101, data server 103, data server 105, data server 107, device 131, database 141) that are linked through communication network 114. However, in some embodiments, aspects of this disclosure can be practiced on stand-alone computers. In some embodiments employing the disclosed systems over a distributed computing environment, program modules can be located in both local and remote memory storage devices. In another aspect, business intelligence system 117 can also comprise second determination component 210 that determines the one or more values corresponding to the threshold maturity level based on a set of risk criteria and the comparison of the set of compliance program data or the set of remediation data to the set of requirement data.

In a non-limiting embodiment, system 200 can include a business intelligence system 117 that can facilitate a determination of a maturity level representing a state of compliance and a risk score representing a vulnerability of a set of protected data. In an aspect, business intelligence system 100 can execute (e.g., as an application, etc.) on a data server device 107 that employs processor 112 to execute a first determination component 110 that can determine a maturity level representing a state of compliance based in part on a comparison of a set of compliance program requirement data and a set of remediation data. In an aspect, a maturity level can indicate a state of compliance achieved at a given moment in time by an entity (e.g., device, user, organization, etc.) that accesses, is capable of accessing, receives, generates, manages, stores, transmits, and/or utilizes confidential information such as protected health information (PHI) or electronic protected health information (EPHI) that requires such entity to abide by various rules and regulations.

In an instance, business intelligence system 117 can employ scoring component 120 to generate a risk score representing an estimated impact of threat data, vulnerability data, or non-compliance data and such subsets of data can contribute to the generation of the risk score. Furthermore, the risk score can be based on values associated with a maturity level and a comparison of such values to one or more values corresponding to a maturity level. In an aspect, second determination component 210 can determine values associated with maturity thresholds in order to determine a risk score. As such, processor 112 can execute determination component 210 to determine a risk score by comparing a value associated with the maturity level to adjusted values that standardized the maturity levels to account for risk factors related to threat data or vulnerability data.

For instance, the determined (e.g., using determination component 110) maturity level corresponds to the state of compliance of the client activities and also consider remediation tasks that enhance the state of compliance of the client activities even further. However, second determination component 210 allows for the consideration of riskiness and susceptibility of client activities and operations to damaging events. For instance, although client data can indicate that the client is in compliance with regulatory requirements, the client can still be exposed to data manipulation (e.g., personnel within client organization), data destruction (e.g., physical destruction of data or software code, or hardware), theft of identity data, ransoming data, unauthorized access to authorized assets, improper disposal of data, and other such vulnerabilities. As such, regardless of a state of compliance, a client device can be exposed to several risks based on non-compliance related factors (e.g., corrupt work place culture, incomplete inventory of assets, incorrect categorization of assets, failure to correct risk mitigating actions, lack of understanding of asset value, lack of awareness of threats, etc.).

As such, in a non-limiting embodiment, second determination component 210 can determine values of threshold maturity levels that accommodate risk for purposes of comparison to a value associated with the maturity level. For instance, as a non-limiting example, a maturity level may have a value of ninety percent, which, on a rating from zero to one hundred percent could indicate a high level of compliance and a correspondingly high level of maturity associated with such client data. However, the client organization may also comprise risk data that indicates the organization is heavily vulnerable to several risks for data loss due to the presence of an incorrect system classification component that organizes EPHI data. As such, the threshold maturity level can be determined by second determination component 210 to be a high value such as twenty. Furthermore, scoring component 120 can determine that a higher risk score is generated for maturity level values less than twenty and lower risk scores are generated for maturity levels higher than values of twenty. As such, second determination component 210 in connection with scoring component 120 can determine a higher risk score associated with such client due to the risks mentioned above.

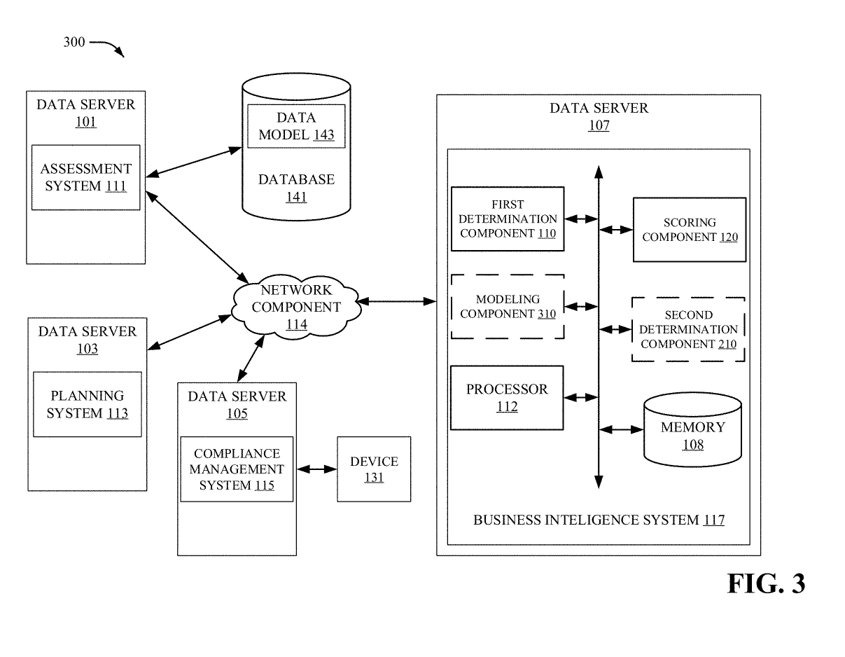

Turning now to FIG. 3, illustrated is a block diagram of an example, non-limiting system 300 that can facilitate a generation of visual depictions of maturity levels and risk scores in accordance with one or more embodiments described herein. Repetitive description of like elements employed in other embodiments described herein is omitted for sake of brevity.

In an aspect, system 300 can comprise data server 101, data server 103, data server 105, data server 107, device 131, and database 141, and/or network 114. In an aspect, data server 101 can include an assessment system 111. In another aspect, database 141 can comprise a data model 143. In yet another aspect, data server 103 can comprise a planning system 113. Furthermore, in an aspect, data server 105 can comprise a compliance management system 115. In another aspect, data server 107 can comprise a business intelligence system 117 that can include a first determination component 110, a scoring component 120, a second determination component 210, a processor 112, and a memory 108. In an aspect, network 114 can represent a distributed computing environment where tasks are performed by remote processing devices (e.g., data server 101, data server 103, data server 105, data server 107, device 131, database 141) that are linked through communication network 114. However, in some embodiments, aspects of this disclosure can be practiced on stand-alone computers. In some embodiments employing the disclosed systems over a distributed computing environment, program modules can be located in both local and remote memory storage devices. In another aspect, business intelligence system 117 can also comprise second determination component 210 that determines the one or more values corresponding to the threshold maturity level based on a set of risk criteria and the comparison of the set of compliance program data or the set of remediation data to the set of requirement data.

In a non-limiting embodiment, system 300 can also include a business intelligence system 117 that can employ a modeling component 310 that generates an interactive graphical model representing the risk score or the maturity level. In an aspect, modeling component 310 can be configured to depict visual and graphical representations of a maturity level, a maturity score (e.g., generated using scoring component 120 based on a comparison of a maturity level with a non-risk adjusted threshold maturity level), a risk score, a regulation maturity level, a control maturity level, a current maturity level by independent control, a maturity improvement by family, an overall risk score, poorly conforming regulations by domain, poorly conforming controls by domain, total risk by risk event, total risk by actor, top risks by control family, top risk by regulation family, and/or depictions of other such metrics.

In an aspect, modeling component 310 can generate an interactive graphical model to depict visual representations. In an aspect, a visual representation can include charts, graphics, texts, graphs, and other visualizations presented at a graphical user interface (GUI) in order to visualize and comprehend the data metrics efficiently. For instance, processor 112 can employ modeling component 310 to generate a circle graph model that depicts a maturity of a HIPAA regulation based on a maturity level determined by first determination component 110. As such, the chart can be color coded and categorize regulation maturities as “partially conforming”, “mostly conforming”, “somewhat conforming”, and “fully conforming”. The greater area of the circle occupied a color corresponding to a maturity category (e.g., mostly conforming), indicates that the client data is compliant with such HIPAA regulation (e.g., an independent HIPAA regulation, a group of regulations, or the entire set of regulations, etc.) in such quantum. The client device can target to achieve a goal where the entire circle is the color corresponding to the “fully conforming” category.

In another aspect, processor 112 can execute modeling component 310 to generate an interactive graphical model representing the risk score. For instance, an overall risk score can be depicted as a semicircle with a first color (e.g., blue) indicating the risk score percentage (e.g., 18.6%) indicating that the client data has a lower risk score and is relatively less vulnerable to threats. In another aspect, a risk impact can be depicted as a bar chart with risks listed by control families (e.g., NIST control families) listed on the Y-axis and the percentage of risk listed on the X-axis. As such, the Y-axis can include the following controls: PE, AU, CA, AC, CM, SI, IA, MP, CP, MA, and IR and the X-axis can comprise percentages such as 0%, 20%, 50%, 60%, 80%, and 100%. In an instance the bar for PE can stretch to 42.9% which is the highest or control within the control family that has the highest impact on risk. In another instance, the IR bar stretches to 10.7% which indicates the control within the control family with the lowest impact on risk.

Furthermore, in an aspect, modeling component 310 can generate an interactive graphical model that is a bar chart comprising a total risk by risk event on the X-axis and an amount of money on the Y-axis. As such the risk event on the X-axis can be a data loss event, a data theft event, a downtime/unavailability event, a patient harm event, a regulatory exposure event, and an unauthorized access event. Accordingly, the data loss bar can extend to a $5,000 amount and a data theft bar amount can extend to a $4,000 amount. As such, the risk events can be visually analyzed based on the projected cost of each risk event. In another aspect, modeling component 310 can generate a bar chart that depicts a total risk by actor comprising actors on the X-axis and dollar amounts on the Y-axis. As such, the actors can include a malicious outsider, a malicious insider, an unintentional actor, a natural actor, and a structural actor. Thus, the malicious outsider actor can have a bar that extends to the $9,000 amount and the unintentional actor can have a bar that extends to the $7,500 amount. Accordingly, such risks by actors can be visually depicted to facilitate an analysis of such risks in a more efficient and comparable manner.

In another aspect, modeling component 310 can generate an interactive graphical model that lists a change in risk as a percentage and a change in maturity as a percentage based on a difference between determined (e.g., using first determination component 110) maturity levels from an older assessment and maturity levels (e.g., using first determination component 110) from a current assessment. For instance, an older assessment can utilize data associated with an NIST control maturity, HIPAA regulation maturity, overall HIPAA safeguard maturity, and an overall NIST control maturity to determine a change in maturity level between a previous and current assessment. Furthermore, all such data utilized to quantify changes can be generated as a graphical model representation (using modeling component 310). In an aspect the difference between an overall risk score (e.g., 18.6%) at a previous assessment time and an overall risk score (e.g., 18.5%) current assessment time can indicate a change in risk (e.g., −0.03%) as a percentage.

In another aspect, modeling component 310 can generate a bar chart with NIST control families on the Y-axis and percentages on the X-axis to represent a maturity improvement by family in graphical data form. Furthermore, in an aspect, modeling component 310 can generate a bar chart depicting current maturity by control with the individual controls listed on the X-axis and percentages listed on the Y-axis. Furthermore, the bar can comprise a percentage of each control maturity ascribed to a control average and percentage ascribed to a final score. In an aspect, such bar chart can provide a snapshot of all the controls and its progress completed for each control. As such, modeling component 310 can generate interactive models based on the maturity level data and risk score data. The models can be graphical and client devices (e.g., device 131) can update the data, adjust the data, toggle the items on each axis and make adjustments to visualize various depictions and changes to such data.

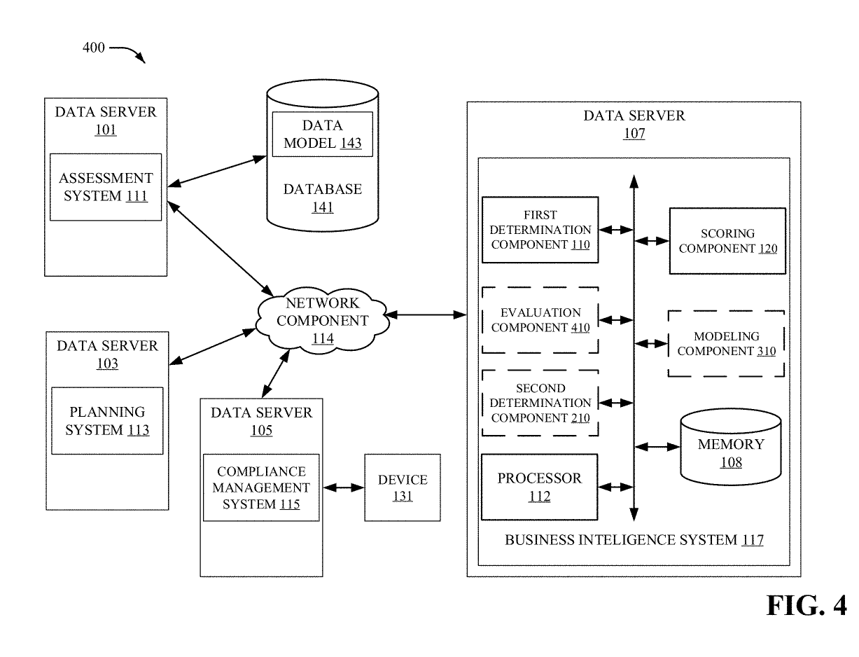

Turning now to FIG. 4, illustrated is a block diagram of an example, non-limiting system 400 that can facilitate an evaluation of the set of risk criteria in accordance with one or more embodiments described herein. Repetitive description of like elements employed in other embodiments described herein is omitted for sake of brevity.

In an aspect, system 400 can comprise data server 101, data server 103, data server 105, data server 107, device 131, and database 141, and/or network 114. In an aspect, data server 101 can include an assessment system 111. In another aspect, database 141 can comprise a data model 143. In yet another aspect, data server 103 can comprise a planning system 113. Furthermore, in an aspect, data server 105 can comprise a compliance management system 115. In another aspect, data server 107 can comprise a business intelligence system 117 that can include a first determination component 110, a scoring component 120, a second determination component 210, modeling component 310, a processor 112, and a memory 108. In an aspect, network 114 can represent a distributed computing environment where tasks are performed by remote processing devices (e.g., data server 101, data server 103, data server 105, data server 107, device 131, database 141) that are linked through communication network 114. However, in some embodiments, aspects of this disclosure can be practiced on stand-alone computers. In some embodiments employing the disclosed systems over a distributed computing environment, program modules can be located in both local and remote memory storage devices. In another aspect, business intelligence system 117 can also comprise second determination component 210 that determines the one or more values corresponding to the threshold maturity level based on a set of risk criteria and the comparison of the set of compliance program data or the set of remediation data to the set of requirement data.

In a non-limiting embodiment, system 400 can also include a business intelligence system 117 that can employ an evaluation component 410 that evaluates the set of risk criteria comprising at least one or more of asset classification data, threat identification data, vulnerability assessment data, risk impact data, risk ranking data, and risk strategy data. In an aspect, a risk score can be generated (e.g., using scoring component 120) based on compliance data associated with the customized compliance plan and the remediation plan, however, the risk score can also be generated based on a set of risk criteria. In an aspect, evaluation component 410 can evaluate the client data for risks. In an instance, evaluation component 410 can compare the client data to risk data to identify one or more risks related to compliance data as well as one or more risks not related to compliance data.

For instance, in an aspect, asset classification data can include a security categorization of all information types associated with the client data. Furthermore, security categories can include hardware asset data, software asset data, and physical work environment data. In another aspect, processor 112 can execute evaluation component 410 to evaluate the threats associated with client data. For instance, if client data is aggregated on a single or few systems, then a security threat to such one or few systems can be catastrophic or have a large impact on the client data. In another aspect, threat data can be evaluated (e.g., using evaluation component 410 based on whether a vulnerable system is critical to the functionality of the overall client system architecture. If such, system is critical to the functionality of the overall client system architecture then the impact from a threat can be large and the risk can be accordingly determined to be great if such system is vulnerable to one or more threat.

In another aspect, impact data can determine the type of impact a threat can have on client data. For instance, a threat may have an impact on administrative data, management data, service information data, but not physical location assets. In another aspect, vulnerability assessment data can include an identification of data corresponding to information types that are input into, stored in, processed by and/or output from each system under review. Furthermore, vulnerability assessment data represents the vulnerabilities associated with such data types. In an aspect, evaluation component 410 can evaluate levels of risk associated with such data types. For instance, a low level of risk can include the loss of confidentiality (e.g., unauthorized disclosure of PHI data), integrity (e.g., unauthorized modification of PHI data) or availability (e.g., disruption of access to or use of PHI data) expected to have a limited adverse effect on organizational operations, organizational assets or personnel. In another instance, evaluation component 410 can evaluate data to determine a moderate level of risk is present in which the loss of confidentiality, integrity, or availability of client data can cause a serious adverse effect on organizational operations, organizational assets or individuals. Furthermore, in an instance evaluation component 410 can evaluate data to determine a high level of risk is present in association with severe or catastrophic impacts result from the loss of confidentiality of client data. Furthermore, a risk score can be generated (e.g., using scoring component 120) based in part on an evaluation (e.g., using evaluation component 410) of impact of risks to indicate the magnitude of harm caused to client operations, assets or personnel (e.g., including users) resulting from a loss of confidentiality, integrity or availability of client data.

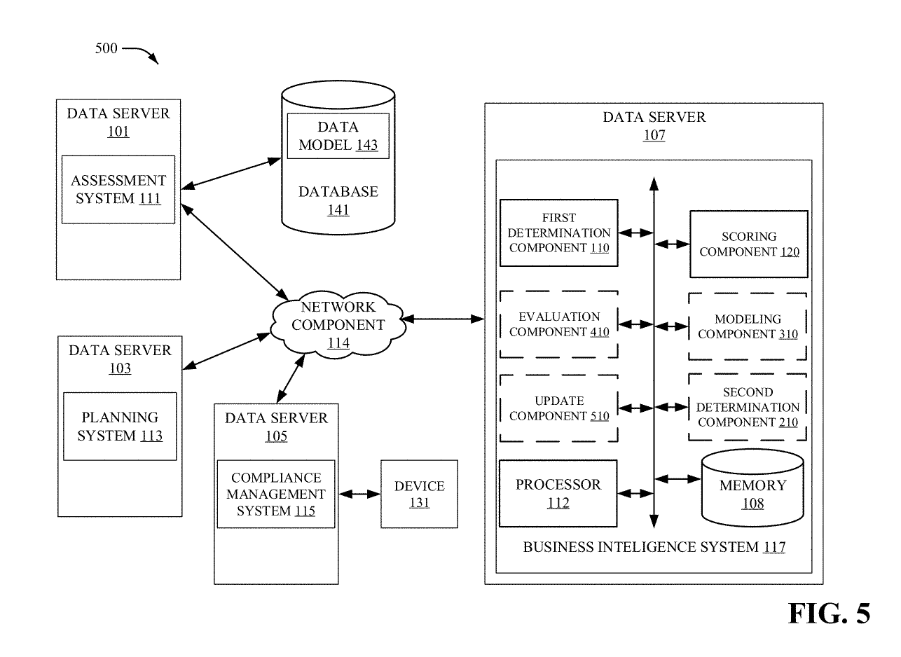

Turning now to FIG. 5, illustrated is a block diagram of an example, non-limiting system 500 that can facilitate an update of a maturity level or risk score in accordance with one or more embodiments described herein. Repetitive description of like elements employed in other embodiments described herein is omitted for sake of brevity.

In an aspect, system 500 can comprise data server 101, data server 103, data server 105, data server 107, device 131, and database 141, and/or network 114. In an aspect, data server 101 can include an assessment system 111. In another aspect, database 141 can comprise a data model 143. In yet another aspect, data server 103 can comprise a planning system 113. Furthermore, in an aspect, data server 105 can comprise a compliance management system 115. In another aspect, data server 107 can comprise a business intelligence system 117 that can include a first determination component 110, a scoring component 120, a second determination component 210, modeling component 310, evaluation component 410, a processor 112, and a memory 108. In an aspect, network 114 can represent a distributed computing environment where tasks are performed by remote processing devices (e.g., data server 101, data server 103, data server 105, data server 107, device 131, database 141) that are linked through communication network 114. However, in some embodiments, aspects of this disclosure can be practiced on stand-alone computers. In some embodiments employing the disclosed systems over a distributed computing environment, program modules can be located in both local and remote memory storage devices. In another aspect, business intelligence system 117 can also comprise second determination component 210 that determines the one or more values corresponding to the threshold maturity level based on a set of risk criteria and the comparison of the set of compliance program data or the set of remediation data to the set of requirement data.

In a non-limiting embodiment, system 500 can also include a business intelligence system 117 that can employ an update component 510 that updates the maturity level or the risk score based on a modification of the set of compliance program data or the set of remediation data to the set of requirement data. In an aspect, client data is dynamic in that it is continuously updated. The client data is continuously updated with new tasks, changes in existing tasks, and revisions to compliance plans. Also, host data is continuously updated to reflect new regulations, new controls, revisions to existing controls and regulations, as well as changes to best practices and other host data. Furthermore, as remediation tasks are carried out, modifications are made to remediation data corresponding to remediation plans and compliance data corresponding to customized compliance plans. Accordingly, updates to such data sets can result in an occurrence of updates (e.g., using update component 510), modifications, amendments, and changes to maturity level data and risk scores. For instance, as compliance items are remediated, the updates to remediation data can result in a determination (e.g., using first determination component 110) and an update (e.g., using update component 510) to maturity level data. Furthermore, in an instance, such remediation data updates and compliance data updates can result in updates (e.g., using update component 510) to and changes in generated (e.g., using scoring component 120) risk score data because of the potential remediation of tasks or operations previously considered risky.

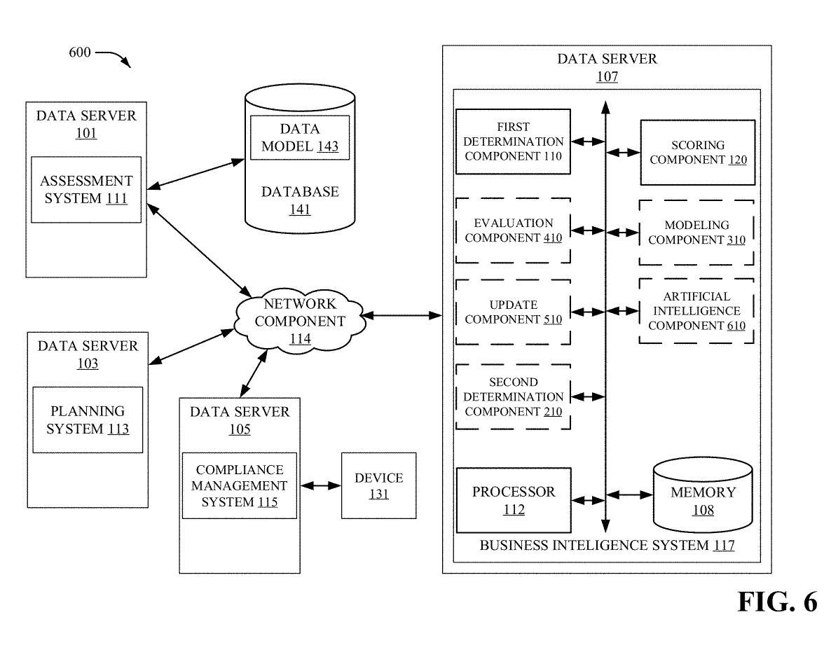

Turning now to FIG. 6, illustrated is a block diagram of an example, non-limiting system 600 that can facilitate a prediction in growth of one or more maturity level in accordance with one or more embodiments described herein. Repetitive description of like elements employed in other embodiments described herein is omitted for sake of brevity.

In an aspect, system 600 can comprise data server 101, data server 103, data server 105, data server 107, device 131, and database 141, and/or network 114. In an aspect, data server 101 can include an assessment system 111. In another aspect, database 141 can comprise a data model 143. In yet another aspect, data server 103 can comprise a planning system 113. Furthermore, in an aspect, data server 105 can comprise a compliance management system 115. In another aspect, data server 107 can comprise a business intelligence system 117 that can include a first determination component 110, a scoring component 120, a second determination component 210, modeling component 310, evaluation component 410, update component 510, a processor 112, and a memory 108. In an aspect, network 114 can represent a distributed computing environment where tasks are performed by remote processing devices (e.g., data server 101, data server 103, data server 105, data server 107, device 131, database 141) that are linked through communication network 114. However, in some embodiments, aspects of this disclosure can be practiced on stand-alone computers. In some embodiments employing the disclosed systems over a distributed computing environment, program modules can be located in both local and remote memory storage devices. In another aspect, business intelligence system 117 can also comprise second determination component 210 that determines the one or more values corresponding to the threshold maturity level based on a set of risk criteria and the comparison of the set of compliance program data or the set of remediation data to the set of requirement data.

In another aspect, business intelligence system 117 can further include an artificial intelligence component 610 that predicts a growth in one or more future maturity level based on a set of forecast data or historical data corresponding to the maturity level. In an aspect, artificial intelligence component 610 can employ various artificial intelligence-based schemes for carrying out various aspects of the system operations. For instance, processor 112 can execute artificial intelligence component 610 to perform a prediction process that predicts one or more achievable maturity levels based on an active learning algorithm that utilizes historical maturity level data inputs to predict future maturity level data. In an aspect, the artificial intelligence component 610 can employ directed or undirected model classification approaches (e.g., naive Bayes, Bayesian networks, decision trees, neural networks, fuzzy logic models, and probabilistic classification models) to provide different predictive patterns of future maturity levels. Furthermore, processor 112 can execute artificial intelligence component 610 to predict risk scores based on projected implementation of compliance activities (e.g., represented by potential compliance data) and remediation activities (e.g., represented by remediation data).

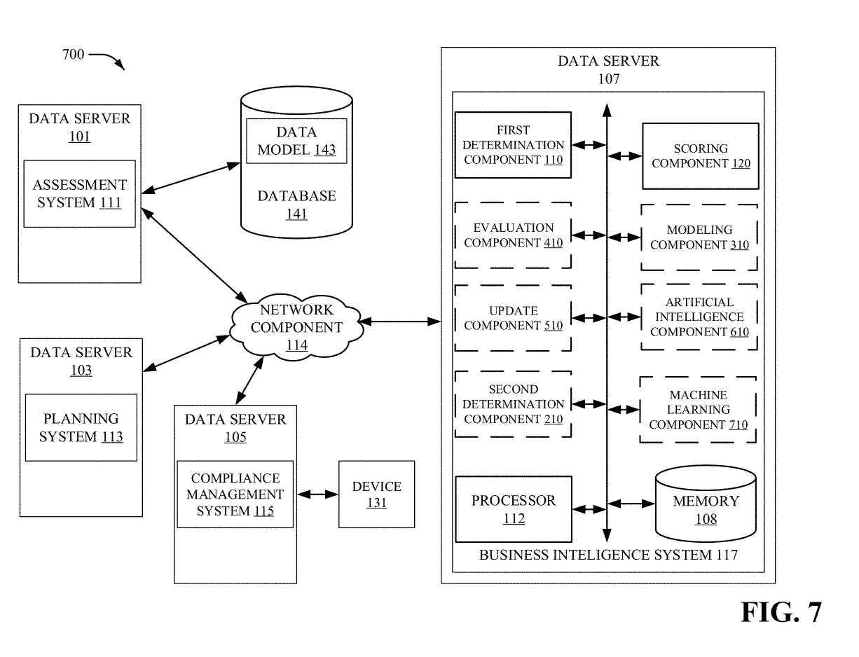

Turning now to FIG. 7, illustrated is a block diagram of an example, non-limiting system 700 that can facilitate employing a machine learning model to label sets of compliance program data based on a level of similarity amongst compliance program data points in accordance with one or more embodiments described herein. Repetitive description of like elements employed in other embodiments described herein is omitted for sake of brevity.

In an aspect, system 700 can comprise data server 101, data server 103, data server 105, data server 107, device 131, and database 141, and/or network 114. In an aspect, data server 101 can include an assessment system 111. In another aspect, database 141 can comprise a data model 143. In yet another aspect, data server 103 can comprise a planning system 113. Furthermore, in an aspect, data server 105 can comprise a compliance management system 115. In another aspect, data server 107 can comprise a business intelligence system 117 that can include a first determination component 110, a scoring component 120, a second determination component 210, modeling component 310, evaluation component 410, update component 510, artificial intelligence component 610, a processor 112, and a memory 108. In an aspect, network 114 can represent a distributed computing environment where tasks are performed by remote processing devices (e.g., data server 101, data server 103, data server 105, data server 107, device 131, database 141) that are linked through communication network 114. However, in some embodiments, aspects of this disclosure can be practiced on stand-alone computers. In some embodiments employing the disclosed systems over a distributed computing environment, program modules can be located in both local and remote memory storage devices. In another aspect, business intelligence system 117 can also comprise second determination component 210 that determines the one or more values corresponding to the threshold maturity level based on a set of risk criteria and the comparison of the set of compliance program data or the set of remediation data to the set of requirement data.

In another aspect, business intelligence system 117 can further include a machine learning component 710 that employs a machine learning model to label sets of compliance program data based on a level of similarity amongst compliance program data points. In a non-limiting embodiment, machine learning component 710 can utilize recurrent neural networks and/or any other suitable machine learning method to generate groupings of compliance data and remediation data related to maturity levels. Accordingly, the compliance data and remediation data can be labeled and grouped into categories (based on the labeling) such as administrative data, physical data, technical data, process data, policy data, and other such data subsets using machine learning techniques. Furthermore, previous client data within such data subsets can be utilized as training data by which new input client data can be compared for grouping into labeled categories. In an aspect, the machine learning techniques of labeling input data can create processor efficiencies (e.g., ability for processor to execute tasks faster) and storage efficiencies (e.g., ability to store and access compliance data, remediation data efficiently). Furthermore, the machine learning techniques employed by machine learning component 710 can help determine maturity levels in real-time based on new updated input data being grouped, labeled and categorized. Furthermore, machine learning component 710 can facilitate a determination of real-time changes to risk score data as well.

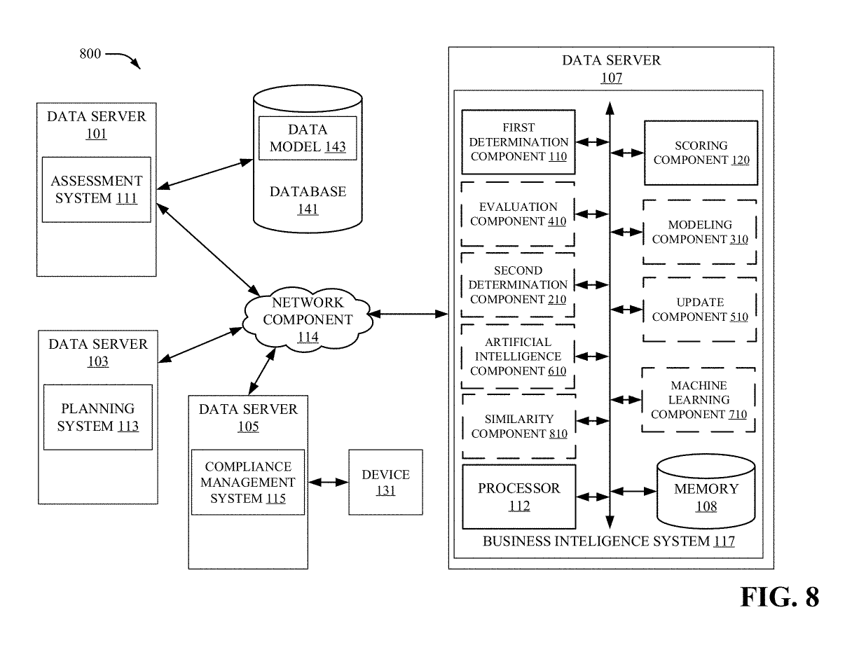

Turning now to FIG. 8, illustrated is a block diagram of an example, non-limiting system 800 that can facilitate an evaluation of the level of similarity between an input set of compliance program data and the labeled sets of compliance program data based on maturity level similarity criteria or compliance element similarity criteria in accordance with one or more embodiments described herein. Repetitive description of like elements employed in other embodiments described herein is omitted for sake of brevity.

In an aspect, system 800 can comprise data server 101, data server 103, data server 105, data server 107, device 131, and database 141, and/or network 114. In an aspect, data server 101 can include an assessment system 111. In another aspect, database 141 can comprise a data model 143. In yet another aspect, data server 103 can comprise a planning system 113. Furthermore, in an aspect, data server 105 can comprise a compliance management system 115. In another aspect, data server 107 can comprise a business intelligence system 117 that can include a first determination component 110, a scoring component 120, a second determination component 210, modeling component 310, evaluation component 410, update component 510, artificial intelligence component 610, machine learning component 710, a processor 112, and a memory 108. In an aspect, network 114 can represent a distributed computing environment where tasks are performed by remote processing devices (e.g., data server 101, data server 103, data server 105, data server 107, device 131, database 141) that are linked through communication network 114. However, in some embodiments, aspects of this disclosure can be practiced on stand-alone computers. In some embodiments employing the disclosed systems over a distributed computing environment, program modules can be located in both local and remote memory storage devices. In another aspect, business intelligence system 117 can also comprise second determination component 210 that determines the one or more values corresponding to the threshold maturity level based on a set of risk criteria and the comparison of the set of compliance program data or the set of remediation data to the set of requirement data.

In another aspect, business intelligence system 117 can further include a similarity component 810 that evaluates the level of similarity between an input set of compliance program data and the labeled sets of compliance program data based on maturity level similarity criteria or compliance element similarity criteria. In an aspect, a similarity component 810 in connection with machine learning component 710 can determine similarities between input compliance data and input remediation data and existing groups of compliance data and remediation data in order to appropriately group the input data with respective groups. In an aspect, an evaluation of similarities (e.g., using similarity component 810) between both groups of data can result in identification of a level of similarity and an interpolation of both sets of data using data displacement techniques. In an aspect, the similarities can be evaluated (e.g., using similarity component 810) based on maturity level criteria such as similarities in characteristics associated with administrative data, process data, physical data, policy data and other types of data subsets. Furthermore, similarity component 810 can determine a similarity level representing a likelihood of similarity between two or more data points (e.g., input data point and training data point). An evaluation resulting in a greater similarity level can indicate a higher likelihood that the input data and training data belong to the same group. Furthermore, the identification of similarity levels between input data and training data can result in direct adjustments to maturity levels and/or risk scores.

In an aspect, similarity component 810 can identify patterns in the client data as compared to host data in order to form heuristics. As such, labeled training data can be utilized by a learning algorithm employed by similarity component 810 in order to facilitate labelling of unlabeled client data. In an aspect, a learning algorithm employed by similarity component 810 can predict a label for the unlabeled client data based on various attributes associated with the data that facilitate its categorization such as administrative data, process data, physical data, policy data and other such data types. In an aspect, using machine learning component 710, the client device can learn the unique data subsets that allow a data subset to be characterized as administrative. Furthermore, similarity component 810 can be employed to predict the presence of such administrative characteristic as applied to test data (e.g., unlabeled data). In an aspect, machine learning component 710 in connection with machine learning component 810 can utilize linear regression (e.g., ordinary least squares technique) to utilize model administrative client data parameters to predict the presence of administrative client data within unlabeled data subsets.

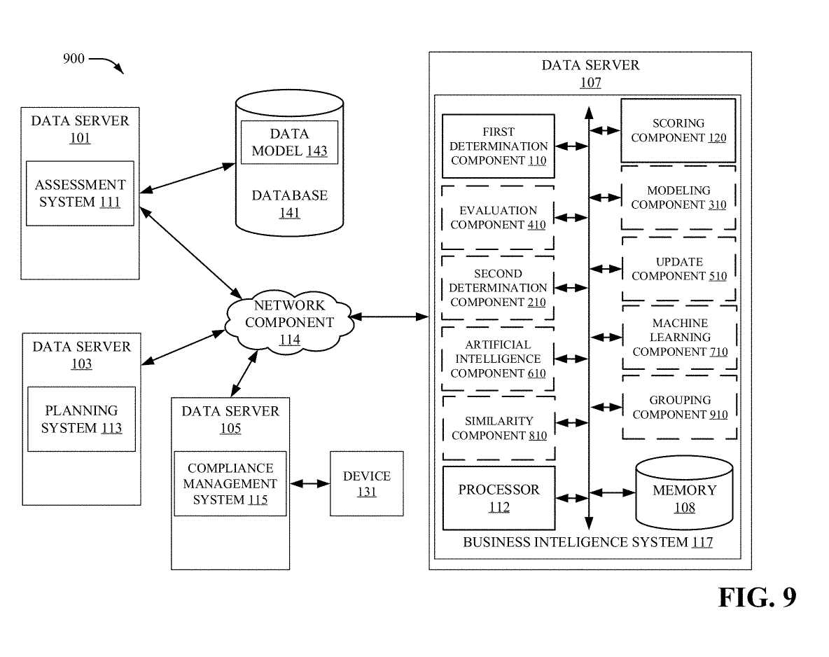

Turning now to FIG. 9, illustrated is a block diagram of an example, non-limiting system 900 that can facilitate a grouping of the intake compliance data into a first labeled set of compliance program data based on a comparison of a similarity value with a similarity level threshold value in accordance with one or more embodiments described herein. Repetitive description of like elements employed in other embodiments described herein is omitted for sake of brevity.

In an aspect, system 900 can comprise data server 101, data server 103, data server 105, data server 107, device 131, and database 141, and/or network 114. In an aspect, data server 101 can include an assessment system 111. In another aspect, database 141 can comprise a data model 143. In yet another aspect, data server 103 can comprise a planning system 113. Furthermore, in an aspect, data server 105 can comprise a compliance management system 115. In another aspect, data server 107 can comprise a business intelligence system 117 that can include a first determination component 110, a scoring component 120, a second determination component 210, modeling component 310, evaluation component 410, update component 510, artificial intelligence component 610, machine learning component 710, similarity component 810, a processor 112, and a memory 108. In an aspect, network 114 can represent a distributed computing environment where tasks are performed by remote processing devices (e.g., data server 101, data server 103, data server 105, data server 107, device 131, database 141) that are linked through communication network 114. However, in some embodiments, aspects of this disclosure can be practiced on stand-alone computers. In some embodiments employing the disclosed systems over a distributed computing environment, program modules can be located in both local and remote memory storage devices. In another aspect, business intelligence system 117 can also comprise second determination component 210 that determines the one or more values corresponding to the threshold maturity level based on a set of risk criteria and the comparison of the set of compliance program data or the set of remediation data to the set of requirement data.

In another aspect, business intelligence system 117 can further include a grouping component 910 that groups the intake compliance data into a first labeled set of compliance program data based on a comparison of a similarity value with a similarity level threshold value. In an aspect, the grouping can allow for the input data (e.g., new compliance data, new remediation data, etc.) to be grouped (e.g., using grouping component 910) with comparatively similar training data (e.g., compliance data, remediation data, etc.) based on an identified similarity (e.g., using similarity component 810). Furthermore, the grouping component 910 can group sets of data in real-time to allow for real-time changes to maturity level data and risk score data.

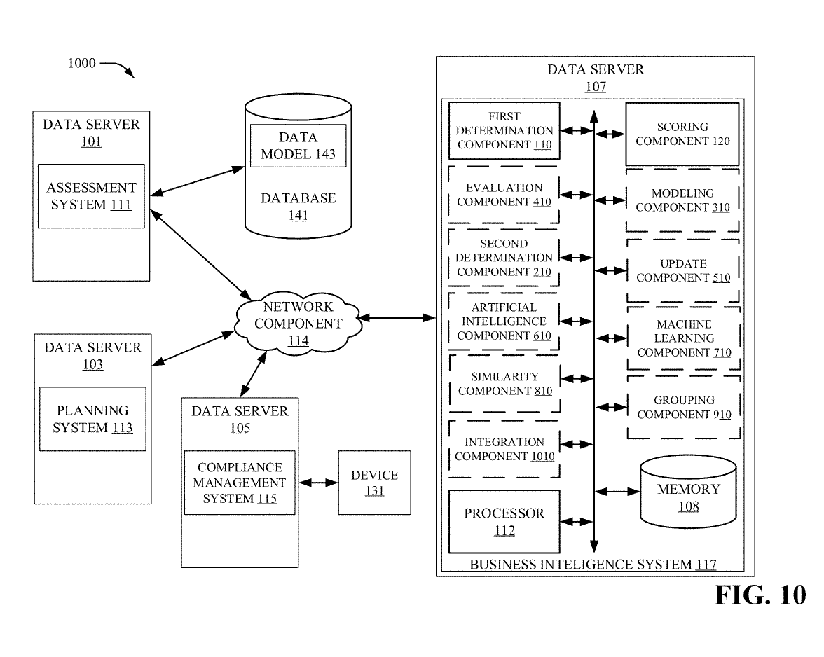

Turning now to FIG. 10, illustrated is a block diagram of an example, non-limiting system 1000 that can facilitate an integration of the threat data, the vulnerability data, and the non-compliance data into comprehensive risk data representing an indicator of overall risk in accordance with one or more embodiments described herein. Repetitive description of like elements employed in other embodiments described herein is omitted for sake of brevity.

In an aspect, system 900 can comprise data server 101, data server 103, data server 105, data server 107, device 131, and database 141, and/or network 114. In an aspect, data server 101 can include an assessment system 111. In another aspect, database 141 can comprise a data model 143. In yet another aspect, data server 103 can comprise a planning system 113. Furthermore, in an aspect, data server 105 can comprise a compliance management system 115. In another aspect, data server 107 can comprise a business intelligence system 117 that can include a first determination component 110, a scoring component 120, a second determination component 210, modeling component 310, evaluation component 410, update component 510, artificial intelligence component 610, machine learning component 710, similarity component 810, grouping component 910, a processor 112, and a memory 108. In an aspect, network 114 can represent a distributed computing environment where tasks are performed by remote processing devices (e.g., data server 101, data server 103, data server 105, data server 107, device 131, database 141) that are linked through communication network 114. However, in some embodiments, aspects of this disclosure can be practiced on stand-alone computers. In some embodiments employing the disclosed systems over a distributed computing environment, program modules can be located in both local and remote memory storage devices. In another aspect, business intelligence system 117 can also comprise second determination component 210 that determines the one or more values corresponding to the threshold maturity level based on a set of risk criteria and the comparison of the set of compliance program data or the set of remediation data to the set of requirement data.

In another aspect, business intelligence system 117 can further include integration component 1010 that integrates the threat data, the vulnerability data, and the non-compliance data into comprehensive risk data representing an indicator of overall risk. In an aspect, integration component 1010 can integrate or merge data subsets and types that require less time and computational resources for execution. Furthermore, in an aspect, the threat data, the vulnerability data, and the non-compliance data can require less time and computational resources for execution by accessing integrated data rather than disparate data subsets. In another aspect, integrated risk data can facilitate more efficient storage and access to risk data that can facilitate business intelligence system 117 to facilitate efficient consumption of resources (e.g., lower computational cost), minimum memory usage (e.g., for data storage), and/or high processing speeds of system 1000 components.

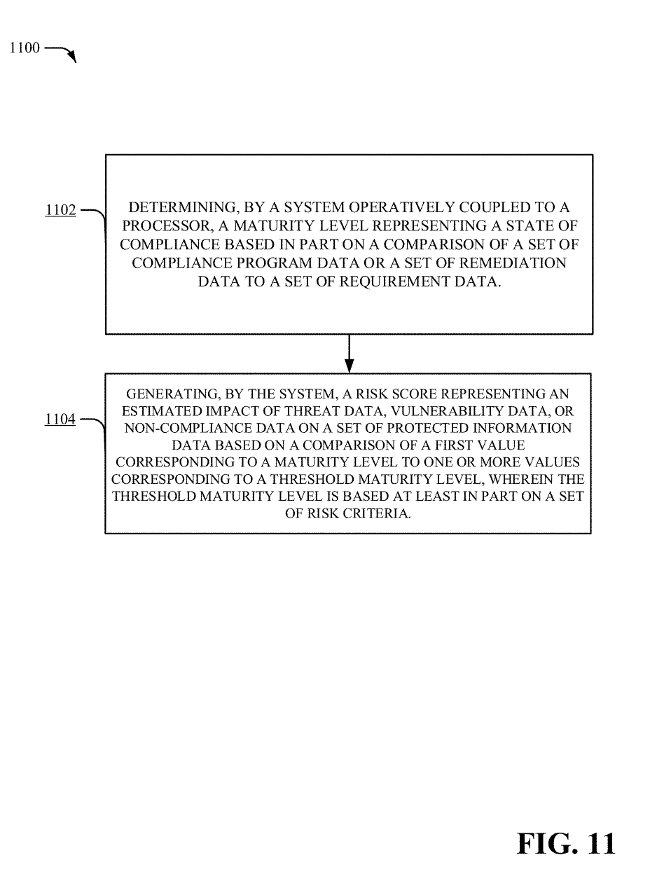

FIG. 11 illustrates a flow diagram of an example, non-limiting computer-implemented method 1100 that can facilitate determination of a maturity level representing a state of compliance and a risk score representing a vulnerability of a set of protected data in accordance with one or more embodiments described herein. In an aspect, one or more of the components described in computer-implemented method 1100 can be electrically and/or and in a wide range of mediums communicatively coupled to one or more devices. Repetitive description of like elements employed in other embodiments described herein is omitted for sake of brevity.

In some implementations, at reference numeral 1102, a system operatively coupled to a processor (e.g., processor 112) can determine (e.g., using first determination component 110) a maturity level representing a state of compliance based in part on a comparison of a set of compliance program data or a set of remediation data to a set of requirement data. In another aspect, at reference numeral 1104, the system can generate (e.g., using scoring component 120) a risk score representing an estimated impact of threat data, vulnerability data, or non-compliance data on a set of protected information data based on a comparison of a first value corresponding to a maturity level to one or more values corresponding to a threshold maturity level, wherein threshold maturity level is based at least in part on a set of risk criteria.

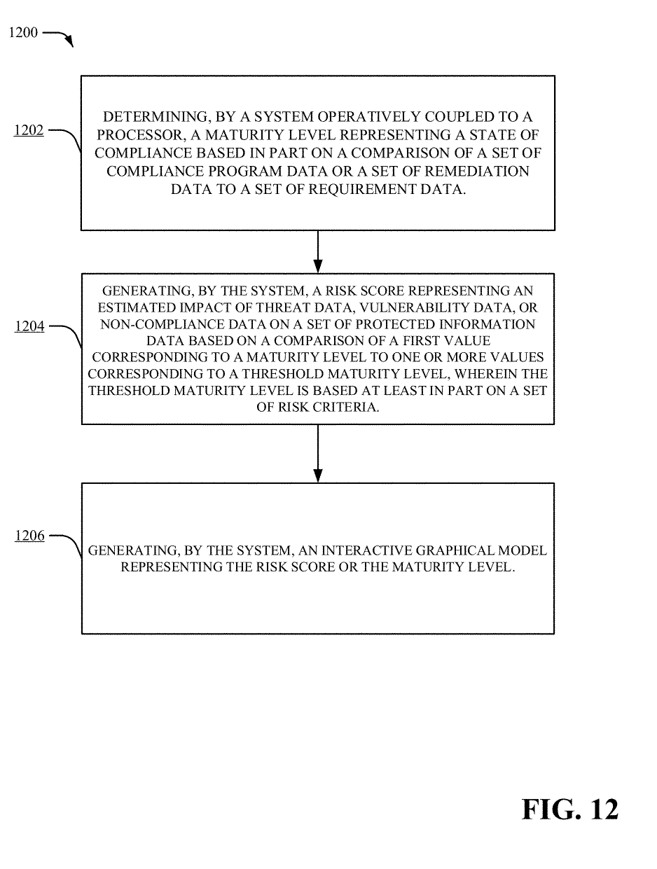

FIG. 12 illustrates a flow diagram of an example, non-limiting computer-implemented method 1200 that can facilitate determination of a maturity level representing a state of compliance and a risk score representing a vulnerability of a set of protected data in accordance with one or more embodiments described herein. In an aspect, one or more of the components described in computer-implemented method 1200 can be electrically and/or and in a wide range of mediums communicatively coupled to one or more devices. Repetitive description of like elements employed in other embodiments described herein is omitted for sake of brevity.

In some implementations, at reference numeral 1202, a system operatively coupled to a processor (e.g., processor 112) can determine (e.g., using first determination component 110) a maturity level representing a state of compliance based in part on a comparison of a set of compliance program data or a set of remediation data to a set of requirement data. In another aspect, at reference numeral 1204, the system can generate (e.g., using scoring component 120) a risk score representing an estimated impact of threat data, vulnerability data, or non-compliance data on a set of protected information data based on a comparison of a first value corresponding to a maturity level to one or more values corresponding to a threshold maturity level, wherein threshold maturity level is based at least in part on a set of risk criteria. At reference numeral 1206, the system generates (e.g., using modeling component 310) an interactive graphical model representing the risk score or the maturity level.

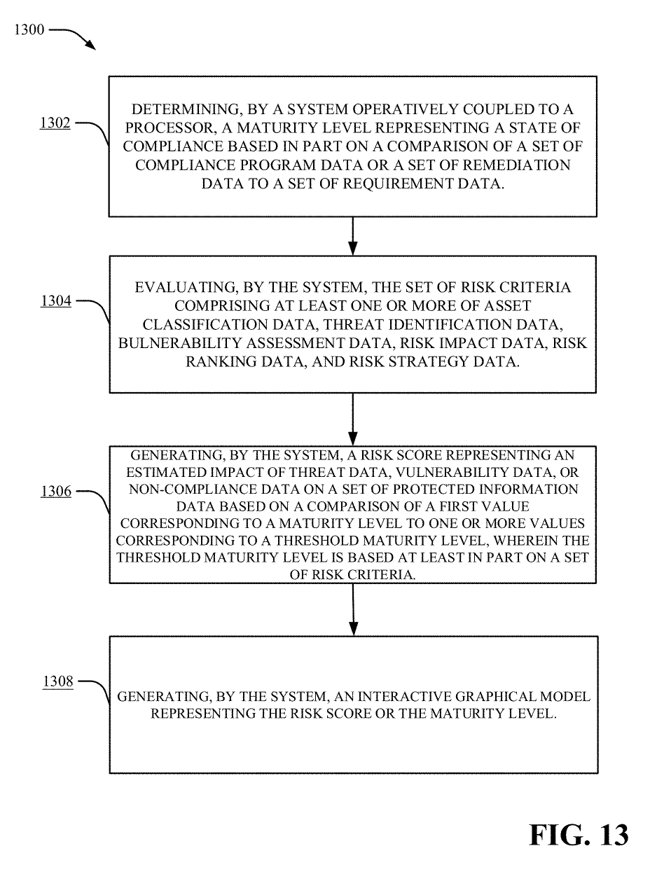

FIG. 13 illustrates a flow diagram of an example, non-limiting computer-implemented method 1300 that can facilitate determination of a maturity level representing a state of compliance and a risk score representing a vulnerability of a set of protected data in accordance with one or more embodiments described herein. In an aspect, one or more of the components described in computer-implemented method 1300 can be electrically and/or and in a wide range of mediums communicatively coupled to one or more devices. Repetitive description of like elements employed in other embodiments described herein is omitted for sake of brevity.

In some implementations, at reference numeral 1302, a system operatively coupled to a processor (e.g., processor 112) can determine (e.g., using first determination component 110) a maturity level representing a state of compliance based in part on a comparison of a set of compliance program data or a set of remediation data to a set of requirement data. At reference numeral 1304, the system evaluates (e.g., using evaluation component 410) the set of risk criteria comprising at least one or more of asset classification data, threat identification data, vulnerability assessment data, risk impact data, risk ranking data, and risk strategy data. In another aspect, at reference numeral 1306, the system can generate (e.g., using scoring component 120) a risk score representing an estimated impact of threat data, vulnerability data, or non-compliance data on a set of protected information data based on a comparison of a first value corresponding to a maturity level to one or more values corresponding to a threshold maturity level, wherein threshold maturity level is based at least in part on a set of risk criteria. At reference numeral 1308, the system generates (e.g., using modeling component 310) an interactive graphical model representing the risk score or the maturity level.

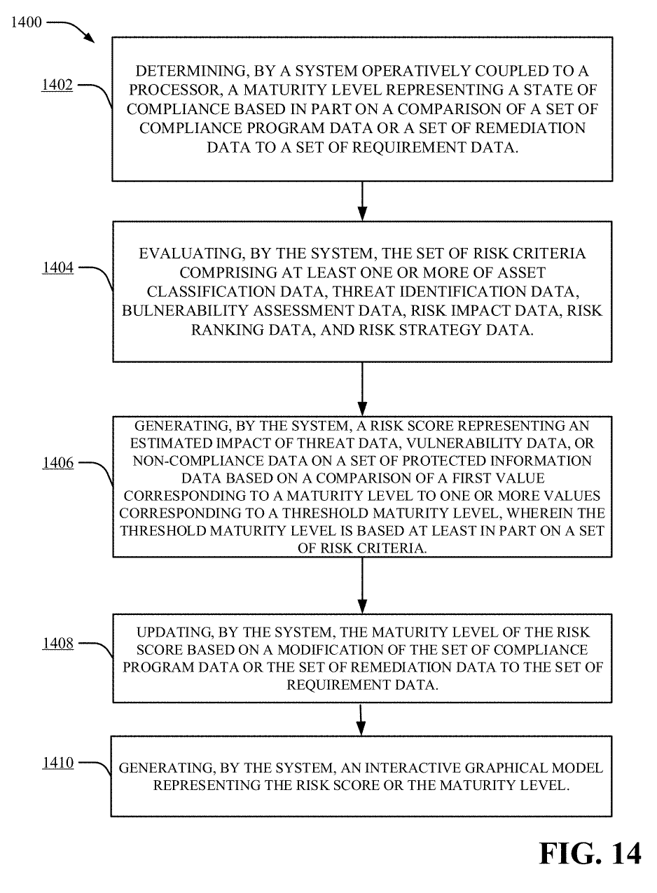

FIG. 14 illustrates a flow diagram of an example, non-limiting computer-implemented method 1400 that can facilitate determination of a maturity level representing a state of compliance and a risk score representing a vulnerability of a set of protected data in accordance with one or more embodiments described herein. In an aspect, one or more of the components described in computer-implemented method 1400 can be electrically and/or and in a wide range of mediums communicatively coupled to one or more devices. Repetitive description of like elements employed in other embodiments described herein is omitted for sake of brevity.

In some implementations, at reference numeral 1402, a system operatively coupled to a processor (e.g., processor 112) can determine (e.g., using first determination component 110) a maturity level representing a state of compliance based in part on a comparison of a set of compliance program data or a set of remediation data to a set of requirement data. At reference numeral 1404, the system evaluates (e.g., using evaluation component 410) the set of risk criteria comprising at least one or more of asset classification data, threat identification data, vulnerability assessment data, risk impact data, risk ranking data, and risk strategy data. In another aspect, at reference numeral 1406, the system can generate (e.g., using scoring component 120) a risk score representing an estimated impact of threat data, vulnerability data, or non-compliance data on a set of protected information data based on a comparison of a first value corresponding to a maturity level to one or more values corresponding to a threshold maturity level, wherein threshold maturity level is based at least in part on a set of risk criteria. At reference numeral 1408, the system updates (e.g., using update component 510) the maturity level of the risk score based on a modification of the set of compliance program data or the set of remediation data to the set of requirement data. At reference numeral 1410, the system generates (e.g., using modeling component 310) an interactive graphical model representing the risk score or the maturity level.

For simplicity of explanation, the computer-implemented methodologies are depicted and described as a series of acts. It is to be understood and appreciated that the subject innovation is not limited by the acts illustrated and/or by the order of acts, for example acts can occur in various orders and/or concurrently, and with other acts not presented and described herein. Furthermore, not all illustrated acts can be required to implement the computer-implemented methodologies in accordance with the disclosed subject matter. In addition, those skilled in the art can understand and appreciate that the computer-implemented methodologies could alternatively be represented as a series of interrelated states via a state diagram or events. Additionally, it should be further appreciated that the computer-implemented methodologies disclosed hereinafter and throughout this specification are capable of being stored on an article of manufacture to facilitate transporting and transferring such computer-implemented methodologies to computers. The term article of manufacture, as used herein, is intended to encompass a computer program accessible from any computer-readable device or storage media.

Moreover, because a determination of maturity levels is performed and generation of risk score is performed utilizing iterative machine learning and artificial intelligence techniques that facilitate a recurrent and precise grouping of unlabeled client data for purposes of determining compliance maturity and impact of risks (e.g., by generating a risk score) associated with such client data based on similarity comparisons is performed by components executed by a processor (e.g., processor 112) established from a combination of electrical and mechanical components and circuitry, a human is unable to replicate or perform the subject data packet configuration and/or the subject communication between processing components (e.g. first determination component 110, scoring component 120, machine learning component 710, similarity component 810, etc.). Furthermore, the similarity comparisons between grouped and ungrouped data sets are based on comparative determinations that only a computer can perform such as iterative grouping, evaluation, and review of client data based on unique signatures within the data and use of computer-implemented operations to recognize digital patterns within computer generated data representations to iteratively group data into categorized groups of client data. The generation of digital data based on pattern recognition algorithms and data similarity algorithms as well as storage and retrieval of digitally generated data to and from a memory (e.g., using memory 108) in accordance with computer generated access patterns cannot be replicated by a human.

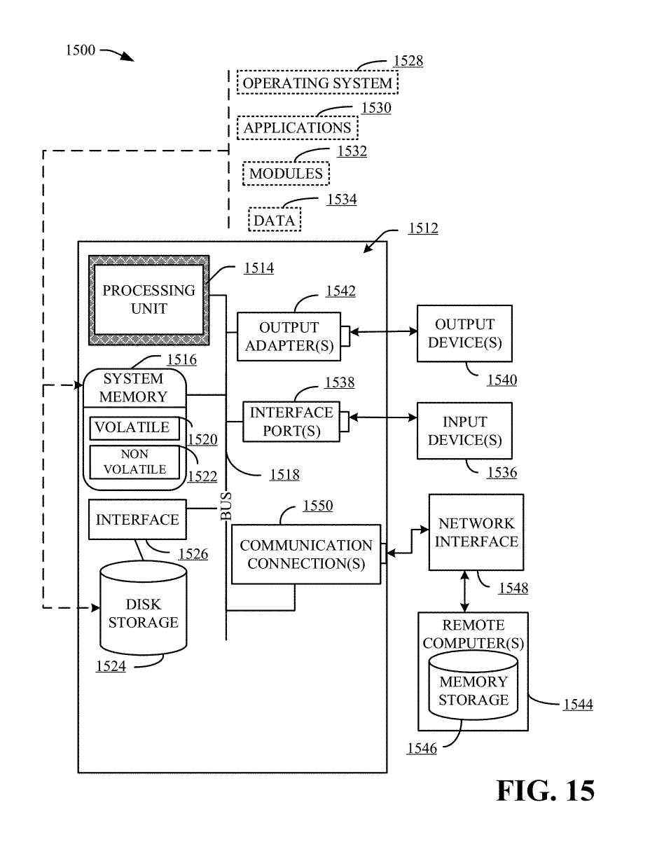

In order to provide a context for the various aspects of the disclosed subject matter, FIG. 15 as well as the following discussion is intended to provide a general description of a suitable environment in which the various aspects of the disclosed subject matter can be implemented. FIG. 15 illustrates a block diagram of an example, non-limiting operating environment in which one or more embodiments described herein can be facilitated. With reference to FIG. 15, a suitable operating environment 1500 for implementing various aspects of this disclosure can also include a computer 1512. The computer 1512 can also include a processing unit 1514, a system memory 1516, and a system bus 1518. The system bus 1518 couples system components including, but not limited to, the system memory 1516 to the processing unit 1514. The processing unit 1514 can be any of various available processors. Dual microprocessors and other multiprocessor architectures also can be employed as the processing unit 1514. The system bus 1518 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Firewire (IEEE 1394), and Small Computer Systems Interface (SCSI).

The system memory 1516 can also include volatile memory 1520 and nonvolatile memory 1522. The basic input/output system (BIOS), containing the basic routines to transfer information between elements within the computer 1512, such as during start-up, is stored in nonvolatile memory 1522. By way of illustration, and not limitation, nonvolatile memory 1522 can include read only memory (ROM), programmable ROM (PROM), electrically programmable ROM (EPROM), electrically erasable programmable ROM (EEPROM), flash memory, or nonvolatile random access memory (RAM) (e.g., ferroelectric RAM (FeRAM). Volatile memory 1520 can also include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM.

Computer 1512 can also include removable/non-removable, volatile/non-volatile computer storage media. FIG. 15 illustrates, for example, a disk storage 1524. Disk storage 1524 can also include, but is not limited to, devices like a magnetic disk drive, floppy disk drive, tape drive, Jaz drive, Zip drive, LS-100 drive, flash memory card, or memory stick. The disk storage 1524 also can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage 1524 to the system bus 1518, a removable or non-removable interface is typically used, such as interface 1526. FIG. 15 also depicts software that acts as an intermediary between users and the basic computer resources described in the suitable operating environment 1500. Such software can also include, for example, an operating system 1528. Operating system 1528, which can be stored on disk storage 1524, acts to control and allocate resources of the computer 1512.

System applications 1530 take advantage of the management of resources by operating system 1528 through program modules 1532 and program data 1534, e.g., stored either in system memory 1516 or on disk storage 1524. It is to be appreciated that this disclosure can be implemented with various operating systems or combinations of operating systems. A user enters commands or information into the computer 1512 through input device(s) 1536. Input devices 1536 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1514 through the system bus 1518 via interface port(s) 1538. Interface port(s) 1538 include, for example, a serial port, a parallel port, a game port, and a universal serial bus (USB). Output device(s) 1540 use some of the same type of ports as input device(s) 1536. Thus, for example, a USB port can be used to provide input to computer 1512, and to output information from computer 1512 to an output device 1540. Output adapter 1242 is provided to illustrate that there are some output device 1540 like monitors, speakers, and printers, among other such output device 1540, which require special adapters. The output adapters 1542 include, by way of illustration and not limitation, video and sound cards that provide a means of connection between the output device 1540 and the system bus 1518. It should be noted that other devices and/or systems of devices provide both input and output capabilities such as remote computer(s) 1544.

Computer 1512 can operate in a networked environment using logical connections to one or more remote computers, such as remote computer(s) 1544. The remote computer(s) 1544 can be a computer, a server, a router, a network PC, a workstation, a microprocessor based appliance, a peer device or other common network node and the like, and typically can also include many or all of the elements described relative to computer 1512. For purposes of brevity, only a memory storage device 1546 is illustrated with remote computer(s) 1544. Remote computer(s) 1544 is logically connected to computer 1512 through a network interface 1548 and then physically connected via communication connection 1550. Network interface 1548 encompasses wire and/or wireless communication networks such as local-area networks (LAN), wide-area networks (WAN), cellular networks, etc. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL). Communication connection(s) 1550 refers to the hardware/software employed to connect the network interface 1548 to the system bus 1518. While communication connection 1550 is shown for illustrative clarity inside computer 1512, it can also be external to computer 1512. The hardware/software for connection to the network interface 1648 can also include, for exemplary purposes only, internal and external technologies such as, modems including regular telephone grade modems, cable modems and DSL modems, ISDN adapters, and Ethernet cards.

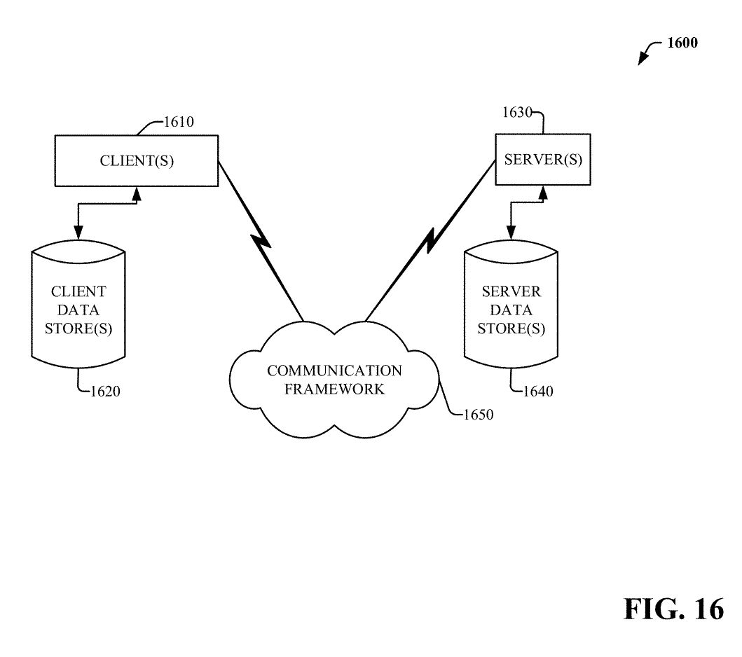

Referring now to FIG. 16, there is illustrated a schematic block diagram of a computing environment 1600 in accordance with this disclosure. The system 1600 includes one or more client(s) 1602 (e.g., laptops, smart phones, PDAs, media players, computers, portable electronic devices, tablets, and the like). The client(s) 1602 can be hardware and/or software (e.g., threads, processes, computing devices). The system 1600 also includes one or more server(s) 1604. The server(s) 1604 can also be hardware or hardware in combination with software (e.g., threads, processes, computing devices). The servers 1604 can house threads to perform transformations by employing aspects of this disclosure, for example. One possible communication between a client 1602 and a server 1604 can be in the form of a data packet transmitted between two or more computer processes wherein the data packet may include video data. The data packet can include a metadata, e.g., associated contextual information, for example. The system 1600 includes a communication framework 1606 (e.g., a global communication network such as the Internet, or mobile network(s)) that can be employed to facilitate communications between the client(s) 1602 and the server(s) 1604.

Communications can be facilitated via a wired (including optical fiber) and/or wireless technology. The client(s) 1602 include or are operatively connected to one or more client data store(s) 1608 that can be employed to store information local to the client(s) 1602 (e.g., associated contextual information). Similarly, the server(s) 1604 are operatively include or are operatively connected to one or more server data store(s) 1610 that can be employed to store information local to the servers 1604. In one embodiment, a client 1602 can transfer an encoded file, in accordance with the disclosed subject matter, to server 1604. Server 1604 can store the file, decode the file, or transmit the file to another client 1602. It is to be appreciated, that a client 1602 can also transfer uncompressed file to a server 1604 and server 1604 can compress the file in accordance with the disclosed subject matter. Likewise, server 1604 can encode video information and transmit the information via communication framework 1606 to one or more clients 1602.

The present disclosure may be a system, a method, an apparatus and/or a computer program product at any possible technical detail level of integration. The computer program product can include a computer readable storage medium (or media) having computer readable program instructions thereon for causing a processor to carry out aspects of the present disclosure. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer and/or computers, those skilled in the art will recognize that this disclosure also can or can be implemented in combination with other program modules. Generally, program modules include routines, programs, components, data structures, etc. that perform particular tasks and/or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments in which tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAIVI). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAIVI), Synchlink DRAM (SLDRAIVI), direct Rambus RAM (DRRAIVI), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising:
a memory that stores computer executable components;
a processor that executes the computer executable components stored in the memory, wherein the computer executable components comprise:
a first determination component that determines a maturity level representing a state of compliance based in part on a comparison of a set of compliance program data or a set of remediation data to a set of requirement data; and
a scoring component that generates a risk score representing an estimated impact of threat data, vulnerability data, or non-compliance data on a set of protected information data based on a comparison of a first value corresponding to a maturity level to one or more values corresponding to a threshold maturity level, wherein the threshold maturity level is based at least in part on a set of risk criteria.

2. The system of claim 1, further comprising a second determination component that determines the one or more values corresponding to the threshold maturity level based on a set of risk criteria and the comparison of the set of compliance program data or the set of remediation data to the set of requirement data.

3. The system of claim 1, further comprising a modeling component that generates an interactive graphical model representing the risk score or the maturity level.

4. The system of claim 1, further comprising an evaluation component that evaluates the set of risk criteria comprising at least one or more of asset classification data, threat identification data, vulnerability assessment data, risk impact data, risk ranking data, and risk strategy data.

5. The system of claim 3, further comprising an update component that updates the maturity level or the risk score based on a modification of the set of compliance program data or the set of remediation data to the set of requirement data.

6. The system of claim 1, further comprising an artificial intelligence component that predicts a growth in one or more future maturity level based on a set of forecast data or historical data corresponding to the maturity level.

7. The system of claim 1, further comprising a machine learning component that employs a machine learning model to label sets of compliance program data based on a level of similarity amongst compliance program data points.

8. The system of claim 7, further comprising a similarity component that evaluates the level of similarity between an input sets of compliance program data and the labeled sets of compliance program data based on maturity level similarity criteria or compliance element similarity criteria.

9. The system of claim 9, further comprising a grouping component that groups the intake compliance data into a first labeled set of compliance program data based on a comparison of a similarity value with a a similarity level threshold value.

10. The system of claim 1, further comprising an integration component that integrates the threat data, the vulnerability data, and the non-compliance data into comprehensive risk data representing an indicator of overall risk.

11. A computer-implemented method, comprising:
determining, by a system operatively coupled to a processor, a maturity level representing a state of compliance based in part on a comparison of a set of compliance program data or a set of remediation data to a set of requirement data; and
generating, by the system, a risk score representing an estimated impact of threat data, vulnerability data, or non-compliance data on a set of protected information data based on a comparison of a first value corresponding to a maturity level to one or more values corresponding to a threshold maturity level, wherein threshold maturity level is based at least in part on a set of risk criteria.

12. The method of claim 11, further comprising generating, by the system, an interactive graphical model representing the risk score or the maturity level.

13. The method of claim 11, further comprising further comprising evaluating, by the system, the set of risk criteria comprising at least one or more of asset classification data, threat identification data, vulnerability assessment data, risk impact data, risk ranking data, and risk strategy data.

14. The method of claim 11, further comprising updating, by the system, the maturity level or the risk score based on a modification of the set of compliance program data or the set of remediation data to the set of requirement data.

15. The method of claim 11, further comprising predicting, by the system, a growth in one or more future maturity level based on a set of forecast data or historical data corresponding to the maturity level.

16. The method of claim 11, further comprising further comprising employing, by the system, a machine learning model to label sets of compliance program data based on a level of similarity amongst compliance program data points.

17. The system of claim 11, further comprising evaluating, by the system, the level of similarity between an input sets of compliance program data and the labeled sets of compliance program data based on maturity level similarity criteria or compliance element similarity criteria.

18. A computer program product for facilitating a determination of a risk level associated with a compliance program, the computer program product comprising a computer readable storage medium having program instructions embodied therewith, the program instructions executable by a processor to cause the processor to:
determine a maturity level representing a state of compliance based in part on a comparison of a set of compliance program data or a set of remediation data to a set of requirement data; and
generate a risk score representing an estimated impact of threat data, vulnerability data, or non-compliance data on a set of protected information data based on a comparison of a first value corresponding to a maturity level to one or more values corresponding to a threshold maturity level, wherein threshold maturity level is based at least in part on a set of risk criteria.

19. The computer program product of claim 18, wherein the program instructions are further executable by the processor to cause the processor to:
integrate the threat data, the vulnerability data, and the non-compliance data into comprehensive risk data representing an indicator of overall risk.

20. The computer program product of claim 18, wherein the program instructions are further executable by the processor to cause the processor to:
determine the one or more values corresponding to the threshold maturity level based on a set of risk criteria and the comparison of the set of compliance program data or the set of remediation data to the set of requirement data.
